(19) United States
(12) Patent Application Publication
(10) Pub. No.: US 2017/0018108 A1
(43) Pub. Date: Jan. 19, 2017

(54) DISPLAY APPARATUS AND CONTROL METHOD THEREOF

(71) Applicant: CANON KABUSHIKI KAISHA, Tokyo (JP)

(72) Inventor: Shinya Oda, Kawasaki-shi (JP)

(21) Appl. No.: 15/204,720

(22) Filed: Jul. 7, 2016

(30) Foreign Application Priority Data
Jul. 13, 2015 (JP) 2015-139933

(51) Int. Cl. G06T 11/60; G06K 7/14; G06T 1/00

(52) U.S. Cl. CPC G06T 11/60; G06T 1/0007; G06K 7/1404

(57) ABSTRACT

A display apparatus including: an imaging unit; a first acquiring unit configured to acquire a photographed image obtained by photographing a plurality of devices by the imaging unit; a recognizing unit configured to recognize each device portrayed in the photographed image; a second acquiring unit configured to acquire information on an image processing function of each of the devices; and a display unit configured to display the photographed image and also, in a case where there is a combination of devices having a common image processing function from among the recognized devices, displaying an image indicating at least one of information on the combination and information on the common image processing function.

### BACKGROUND OF THE INVENTION

Field of the Invention

The present invention relates to a display apparatus and a control method thereof.

Description of the Related Art

In recent years, there has been an emergence of cameras capable of capturing images referred to as 4K (3840×2160), which is four times the resolution of full HD (1920×1080) as well as displays capable of displaying images with 4K resolution. Since 4K has four times the number of pixels of conventional full HD and requires a wide transmission band for image data, displaying a 4K image on a display necessitates connection of a plurality of SDI cables.

4K cameras include those capable of recording RAW data (sensor-output raw data). Displaying 4K RAW data on a display requires, in addition to the display being 4K image-ready, a function for debayering and converting RAW data into RGB data. In addition, since a RAW data format is unique to each manufacturer, the display must also accommodate the format of the RAW data in order to display the RAW data.

Functions with specifications that differ for each manufacturer include gamma which defines a gradation of image data. Recent cameras are capable of handling Log (logarithmic) gamma in addition to conventional exponential gamma. Log gamma enables handling of image data with a wider dynamic range than conventional exponential gamma. However, in order to display Log gamma image data output from a camera, a display must also accommodate Log gamma. In addition, since a Log gamma curve differs for each manufacturer, in order to display image data of Log gamma of a given manufacturer, a gamma table corresponding to the Log gamma of the manufacturer must be used. Furthermore, each manufacturer has a uniquely defined color gamut.

As described above, various standards with different resolutions (4K, 2K, and the like), RAW data formats, gamma, color gamuts, and the like exist with respect to image data to be processed by devices such as cameras and displays, and appropriate processing can only be performed between devices that have the same standard. Therefore, when performing processing for image display, image recording, and the like by connecting a plurality of such devices, a user must appropriately discern standards of image data processed by the respective devices.

Meanwhile, processing capabilities of mobile terminals such as smartphones and tablets have improved dramatically, resulting in widespread use of such mobile terminals. These mobile terminals are equipped with camera units and can also be used as imaging apparatuses (cameras). One function which utilizes a camera is augmented reality (AR). AR refers to a technique which, by combining an image of an object with a photographed image obtained by imaging performed by a camera, enables an observer of the image to have an observational experience that feels as though the object actually exists. Information on an object is encoded using, for example, a marker (an AR code) configured by a two-dimensional array of monochromatic binary rectangles. By arranging an AR code in a space and photographing the AR code with a camera, an image of an object corresponding to the AR code is superimposed at a position of an image of the AR code in a photographed image output from the camera and a combined image is generated in which the object appears as though existing in the space.

There are techniques which use AR to improve usability when using a device such as a printer or a scanner by individually combining, on a photographed image obtained by photographing a space where the device is installed, an image indicating information on the device. Japanese Patent Application Laid-open No. 2013-161246 describes displaying a status in a virtual space when executing data processing using a plurality of network apparatuses such as a printer and a scanner so that a user can readily discern a physical positional relationship among the respective apparatuses.

In addition, Japanese Patent Application Laid-open No. 2013-161246 also describes displaying, in the virtual space, data flow information indicating a flow of data which accompanies processing of image data by a printer or the like. Japanese Patent Application Laid-open No. 2013-172432 describes a technique for recognizing a device in a space from image data of a head-mounted display, displaying a user interface for operating the recognized device, and operating the device using AR.

### SUMMARY OF THE INVENTION

Since conventional art only involves displaying information on individual devices in a photographed image, it is difficult for a user to discern a function common to devices portrayed in a photographed image and to discern whether or not the devices are capable of cooperating with one another.

The present invention provides a technique that enables a user to readily discern a function common to a plurality of image devices and to discern whether or not the image devices can cooperate with one another.

A first aspect of the present invention is a display apparatus including:

an imaging unit;

a first acquiring unit configured to acquire a photographed image obtained by photographing a plurality of devices by the imaging unit;

a recognizing unit configured to recognize each device portrayed in the photographed image;

a second acquiring unit configured to acquire information on an image processing function of each of the devices; and

a display unit configured to display the photographed image and also, in a case where there is a combination of devices having a common image processing function from among the recognized devices, displaying an image indicating at least one of information on the combination and information on the common image processing function.

A second aspect of the present invention is a control method for a display apparatus provided with an imaging unit, the control method including:

capturing an image with the imaging unit;

acquiring a photographed image obtained by photographing a plurality of devices by the imaging unit;

recognizing each device portrayed in the photographed image;

acquiring information on an image processing function of each of the devices; and

displaying the photographed image and also, in a case where there is a combination of devices having a common image processing function among the recognized devices, displaying an image indicating at least one of information on the combination and information on the common image processing function.

A third aspect of the present invention is a non-transitory computer readable storage medium having stored thereon a computer program comprising instructions, which, in a case where executed by a computer, cause the computer to execute respective steps of a control method for a display apparatus including an imaging unit, the program causing a computer to execute:

capturing an image with the imaging unit;

acquiring a photographed image obtained by photographing a plurality of devices by the imaging unit;

recognizing each device portrayed in the photographed image;

acquiring information on an image processing function of each of the devices; and

displaying the photographed image and also, in a case where there is a combination of devices having a common image processing function from among the recognized devices, displaying an image indicating at least one of information on the combination and information on the common image processing function.

According to the present invention, a user can readily discern a function common to a plurality of devices and discern whether or not the image devices can cooperate with one another.

Further features of the present invention will become apparent from the following description of exemplary embodiments with reference to the attached drawings.

### BRIEF DESCRIPTION OF THE DRAWINGS

FIG. 1 is a block diagram of respective devices forming groups of devices to which a first embodiment is applied;

FIG. 2 is a diagram showing an outline of groups of devices to which the first embodiment is applied;

FIG. 3 is a flow chart of processing for displaying a functional information image according to the first embodiment;

FIGS. 4A to 4D are diagrams illustrating display positions of functional information images according to the first embodiment;

FIG. 5 is a diagram illustrating a pattern having two image display apparatuses according to the first embodiment;

FIGS. 6A to 6D are diagrams showing functional information and an identification ID of each device according to the first embodiment;

FIGS. 7A to 7D are diagrams showing a functional information acquisition process according to the first embodiment;

FIG. 8 is a diagram illustrating an example of displaying information on a plurality of pairing-enabled image display apparatuses;

FIG. 9 is a block diagram of respective devices forming groups of devices to which a second embodiment is applied;

FIG. 10 is a flow chart of processing for displaying a functional information image according to the second embodiment;

FIGS. 11A and 11B are diagrams illustrating a functional information image according to the second embodiment;

FIGS. 12A and 12B are diagrams illustrating a functional information image according to the second embodiment;

FIG. 13 is a block diagram of respective devices forming groups of devices to which a third embodiment is applied;

FIG. 14 is a flow chart of processing for displaying a functional information image according to the third embodiment;

FIGS. 15A and 15B are diagrams illustrating a functional information image according to the third embodiment;

FIGS. 16A and 16B are diagrams illustrating a functional information image according to the third embodiment;

FIG. 17 is a block diagram of respective devices forming groups of devices to which a fourth embodiment is applied;

FIG. 18 is a flow chart of processing for displaying a functional information image according to the fourth embodiment;

FIG. 19 is a diagram illustrating a functional information image according to the fourth embodiment;

FIG. 20 is a block diagram of respective devices forming groups of devices to which a fifth embodiment is applied;

FIG. 21 is a flow chart of processing for displaying a functional information image according to the fifth embodiment;

FIG. 22 is a diagram illustrating a functional information image according to the fifth embodiment;

FIGS. 23A to 23C are diagrams showing a cooperation setting of a monitoring target according to the fifth embodiment;

FIG. 24 is a diagram illustrating a functional information image according to the fifth embodiment;

FIG. 25 is a diagram illustrating an AR code; and

FIGS. 26A and 26B show examples of correspondence between function IDs and function names and devices having a common image processing function.

### DESCRIPTION OF THE EMBODIMENTS

### First Embodiment

A first embodiment of the present invention will be described. The first embodiment relates to a method used when performing image processing with a plurality of devices such as a camera and a display in order to display information regarding which devices can be combined and operated in cooperation with each other on a screen of a mobile terminal such as a tablet and a smartphone.

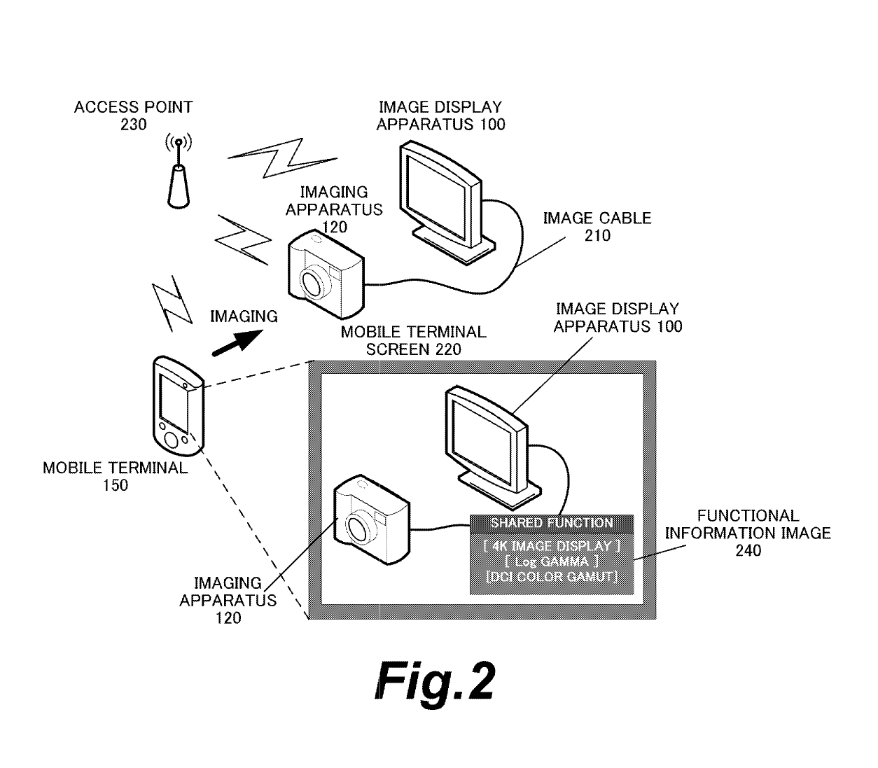

FIG. 2 shows a display apparatus and a group of devices that are application targets of a control method of the display apparatus according to the first embodiment. The group of devices includes an image display apparatus 100, an imaging apparatus 120, and a mobile terminal 150.

The imaging apparatus 120 is a camera capable of photographing a moving image. A photographed image obtained by photography performed by the imaging apparatus 120 is output to the image display apparatus 100 connected by an image cable 210 and displayed by the image display apparatus 100.

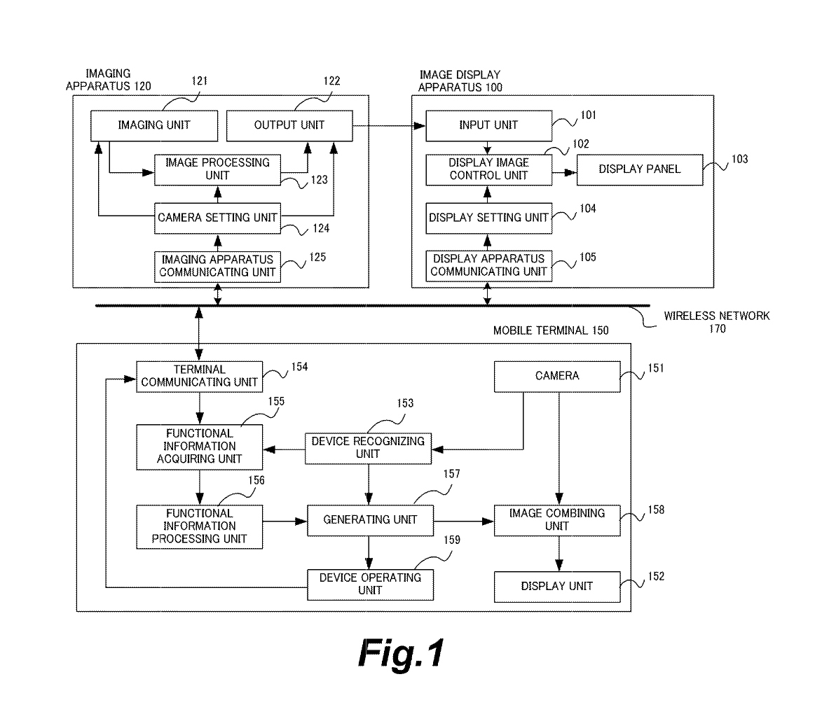

A camera 151 is mounted to the mobile terminal 150 (refer to FIG. 1). The mobile terminal 150 is capable of displaying information related to a plurality of devices on a photographed image obtained by the camera 151 by photographing the plurality of devices. When a plurality of devices portrayed in a photographed image are recognized and a combination of devices having a common image processing function exists among the recognized devices, examples of the information is information on the combination and information on the common image processing function. For example, when recognized devices are a camera capable of recording images with Log gamma and a display capable of displaying Log gamma images, the common image processing function is Log gamma. In this case, the mobile terminal 150 displays information indicating the combination of the camera and the display or information indicating that the image processing function common to the camera and the display is Log gamma together with displaying a photographed image. For example, the mobile terminal 150 performs information display and photographed image display by combining (superimposing) an image indicating the information on the photographed image.

In the first embodiment, information display is performed by combining a functional information image 240 on a photographed image obtained by photographing the imaging apparatus 120 and the image display apparatus 100 with the camera 151 of the mobile terminal 150 and performing display such as shown on a mobile terminal screen 220.

The image display apparatus 100, the imaging apparatus 120, and the mobile terminal 150 are connected to a wireless network 170 (refer to FIG. 1) via an access point 230 and are capable of communicating with one another. Accordingly, the mobile terminal 150 can acquire information on image processing functions (functional information) and current setting states of the image display apparatus 100 and the imaging apparatus 120. In addition, settings of the image display apparatus 100 and the imaging apparatus 120 can be changed from the mobile terminal 150.

FIG. 1 is a block diagram showing a functional configuration of the group of devices described above. Hereinafter, functional configurations of the respective devices will be described.

### Image Display Apparatus 100

A block diagram of the image display apparatus 100 will now be described.

An input unit 101 receives image data from the imaging apparatus 120, converts the received image data into image data to be internally processed by the image display apparatus 100, and outputs the converted image data to a display image control unit 102. For example, let us assume that a signal timing of image data internally processed by the image display apparatus 100 is 60 Hz and a signal timing of image data input from the imaging apparatus 120 is 30 Hz. In this case, the input unit 101 converts the input image data into image data with a signal timing of 60 Hz and outputs the converted image data to the display image control unit 102.

The display image control unit 102 performs image processing on the image data input from the input unit 101 and outputs the processed image data to a display panel 103. Examples of image processing performed by the display image control unit 102 include gamma conversion, color gamut conversion, and color format conversion.

The display panel 103 is a display device such as a liquid crystal panel, an organic electro-luminescence (EL) panel, and a micro electro mechanical systems (MEMS) shutter panel. A liquid crystal panel and a MEMS shutter panel adjust transmittance of light on a per-pixel basis but are not self-luminescent. When the display panel 103 is configured so as to include a liquid crystal panel, a MEMS shutter panel, or the like, the display panel 103 also includes a backlight to act as a light source. On the other hand, an organic EL panel is a light emitting element made of an organic compound and is a self-luminous device. When the display panel 103 is configured so as to include an organic EL panel, the display panel 103 does not include a backlight.

A display setting unit 104 performs settings of the image display apparatus 100. For example, when setting gamma of the image display apparatus 100 to Log (logarithmic) gamma, the display setting unit 104 issues a request to the display image control unit 102 to set a gamma table to Log gamma.

A display apparatus communicating unit 105 communicates with the mobile terminal 150 and the imaging apparatus 120 via the wireless network 170.

### Imaging Apparatus 120

A block diagram of the imaging apparatus 120 will now be described.

An imaging unit 121 converts an optical image into an electric signal and outputs the electric signal as image data. The imaging unit 121 includes an image capturing element such as a CCD (charge-coupled device) and a CMOS (complementary metal-oxide semiconductor), a shutter unit, a lens, and the like. The imaging unit 121 outputs image data obtained by imaging to an image processing unit 123.

An output unit 122 outputs image data subjected to image processing by the image processing unit 123 to the image display apparatus 100 that is an external device. In the first embodiment, it is assumed that a format of image data output by the imaging apparatus 120 can be set to either 2K (1920×1080) or 4K (3840×2160).

The image processing unit 123 performs image processing on image data output from the imaging unit 121 and outputs the processed image data to the output unit 122.

A camera setting unit 124 performs settings of the imaging apparatus 120. For example, the camera setting unit 124 performs settings of a recording format, recording gamma, a color gamut, and output image data format of the imaging apparatus 120 and the like.

An imaging apparatus communicating unit 125 communicates with the image display apparatus 100 and the mobile terminal 150 via the wireless network 170.

### Mobile Terminal 150

A block diagram of the mobile terminal 150 will now be described.

The camera 151 is imaging unit which is a small camera unit including an image capturing element such as a CCD and a CMOS, a shutter unit, a lens, and the like. The camera 151 outputs image data obtained by imaging to a device recognizing unit 153 and an image combining unit 158.

A display unit 152 is display unit that constitutes a screen of the mobile terminal 150. The display unit 152 displays an image based on image data input from the image combining unit 158.

The device recognizing unit 153 is first acquiring unit which acquires a photographed image obtained by photography using the camera 151 and is recognizing unit which recognizes respective devices portrayed in the acquired photographed image such as the image display apparatus 100 and the imaging apparatus 120. In the first embodiment, the device recognizing unit 153 recognizes a device based on an AR code. Housings of the image display apparatus 100 and the imaging apparatus 120 include AR codes that are markers in which identification information of the devices is encoded. The device recognizing unit 153 recognizes a device portrayed in a photographed image by analyzing an image of an AR code included in the photographed image. Conceivable AR codes include an AR code displayed on a housing in a fixed manner by printing or the like and an AR code displayed as an image on a screen in the case of a device having a screen such as the image display apparatus 100 and the imaging apparatus 120. An AR code displayed as an image can be configured so as to be variable in accordance with, for example, a setting or a state of a device.

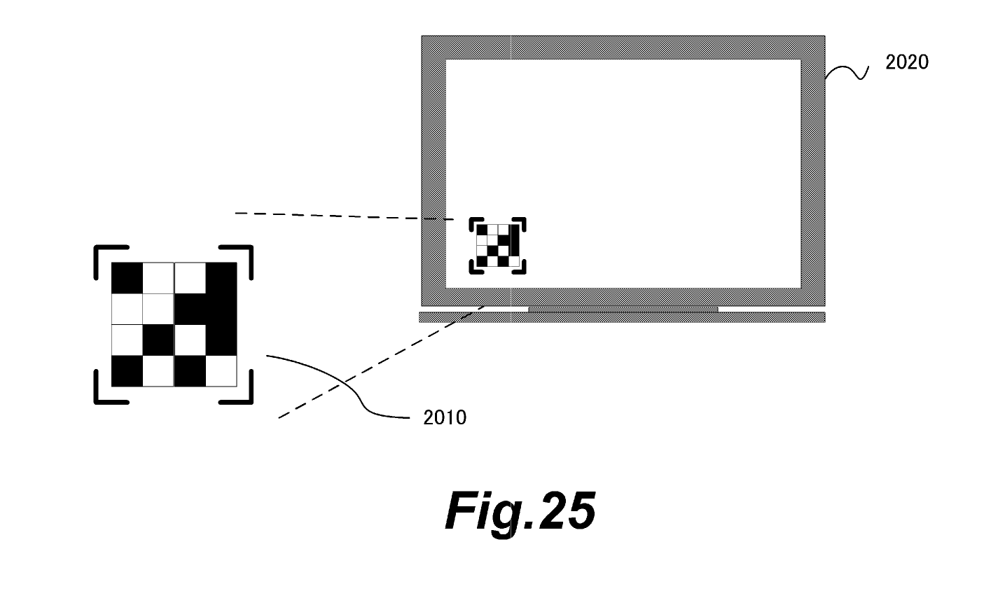

FIG. 25 shows an example of an AR code. An AR code 2010 displayed on an image display apparatus 2020 is a marker constituted by a two-dimensional array of rectangles that assume two values of black and white, in which case information is embedded according to how the rectangles are arranged two-dimensionally.

The device recognizing unit 153 detects a spatial positional relationship among the respective devices from a shape of an image of an AR code included in a photographed image obtained by photography using the camera 151. An AR code having a square shape as shown in FIG. 25 is distorted into a trapezoidal shape, a diamond shape, or the like in accordance with a positional relationship among the camera 151 and the devices in the photographed image. The device recognizing unit 153 detects a spatial position of each device based on the geometric distortion of the AR code.

Once recognition and position detection of each device are completed, the device recognizing unit 153 transmits identification information of each device to a functional information acquiring unit 155. In addition, the device recognizing unit 153 acquires a position (an XY coordinate) of an image of each device in the photographed image obtained by photography using the camera 151 and transmits the acquired position to a generating unit 157. For example, the device recognizing unit 153 may detect an image of each device in the photographed image by image analysis and acquire a position of the image or detect a position of an image of an AR code in the photographed image and acquire the position of the image of the AR code as a position of an image of each device.

A terminal communicating unit 154 communicates with the image display apparatus 100 and the imaging apparatus 120 via the wireless network 170.

The functional information acquiring unit 155 is second acquiring unit which acquires information on an image processing function (functional information) of each device (in this case, the imaging apparatus 120 and the image display apparatus 100) recognized by the device recognizing unit 153. Functional information refers to information related to functions and settings of image processing that can be executed by each device. The functional information acquiring unit 155 acquires functional information from each device via the terminal communicating unit 154. The functional information acquiring unit 155 transmits the acquired functional information of each device to a functional information processing unit 156.

Based on the functional information acquiring unit of each device acquired by the functional information acquiring unit 155, the functional information processing unit 156 determines whether there is a combination of devices having a common image processing function among the devices recognized by the device recognizing unit 153. When such a combination exists, the functional information processing unit 156 outputs at least any of information on the combination and information on the common image processing function to the generating unit 157. For example, when the imaging apparatus 120 is capable of photographing a 4K image and the image display apparatus 100 is capable of displaying a 4K image, a common image processing function is “4K display”. The functional information processing unit 156 transmits the information on the common image processing function to the generating unit 157.

Moreover, when respective devices are devices capable of switching among and executing a plurality of image processing functions by changing settings, the functional information acquiring unit 155 acquires information on the plurality of image processing functions. In this case, the functional information processing unit 156 determines whether there is a combination of devices having at least one common image processing function among the plurality of switchable image processing functions among the recognized devices. When such a combination exists, the functional information processing unit 156 outputs at least any of information on the combination and information on the common image processing function to the generating unit 157.

Based on information on the common image processing function input from the functional information processing unit 156, the generating unit 157 generates an image (functional information image) indicating the common image processing function. The generating unit 157 outputs the generated image to the image combining unit 158.

An example is shown in FIG. 2. In FIG. 2, an image displayed as a functional information image 240 is an image which is generated by the generating unit 157 and which indicates an image processing function common to the image display apparatus 100 and the imaging apparatus 120. Due to a functional information image being displayed together with a photographed image on the screen of the mobile terminal 150, the user can discern that, for example, a cooperative operation can be performed in which the imaging apparatus 120 is connected to the image display apparatus 100 and caused to display a 4K image.

Based on positional information (XY coordinates) of images of the image display apparatus 100 and the imaging apparatus 120 acquired from the device recognizing unit 153, the generating unit 157 determines a display position of the functional information image 240 so as not to overlap with the images of the image display apparatus 100 and the imaging apparatus 120. The generating unit 157 outputs the generated functional information image 240 and information on the display position thereof to the image combining unit 158.

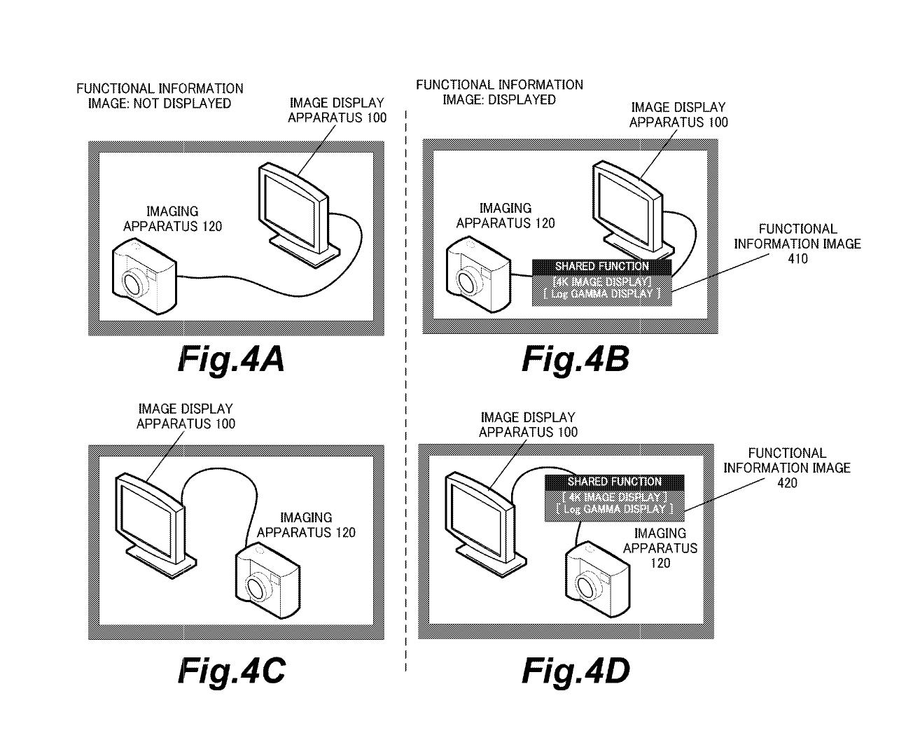

FIG. 4 shows another example. FIGS. 4A and 4C show photographed images obtained by photographing a state where the imaging apparatus 120 and the image display apparatus 100 are connected to each other from different viewpoints with the camera 151. FIGS. 4B and 4D show functional information images 410 and 420 being displayed on the respective photographed images. In each case, the functional information image 410 or 420 is displayed in accordance with positions of images of the image display apparatus 100 and the imaging apparatus 120 at a position that does not overlap with the images of the devices.

Moreover, an image indicating information of each device may be displayed in addition to a functional information image in a photographed image. In this case, the generating unit 157 generates an image indicating device information, determines a display position thereof so that, for example, the device information is displayed in a vicinity of an image of each device in the photographed image, and outputs the image of the device information to the image combining unit 158. For example, device information related to the imaging apparatus 120 is displayed in a vicinity of the image of the imaging apparatus 120.

The image combining unit 158 combines a photographed image input from the camera 151 with a functional information image input from the generating unit 157 and outputs the combined image to the display unit 152.

A device operating unit 159 is setting unit which sets each device so as to operate in a prescribed image processing function. In the first embodiment, when there is a combination of devices determined to have a common image processing function by the functional information processing unit 156, the devices included in the combination are set so as to operate in the common image processing function. In the example shown in FIG. 2, the device operating unit 159 changes settings of the imaging apparatus 120 and the image display apparatus 100. For example, when the common image processing function is “4K display”, the device operating unit 159 issues an instruction via the wireless network 170 to the respective devices to perform operations corresponding to 4K display so that a 4K image can be actually displayed by cooperation between the respective devices. In this case, the device operating unit 159 requests the camera setting unit 124 of the imaging apparatus 120 and the display setting unit 104 of the image display apparatus 100 to change settings of the respective devices so as to correspond to 4K display. While the image display apparatus 100 is capable of both 2K display and 4K display depending on settings, the request causes the image display apparatus 100 to be set so as to correspond to 4K display.

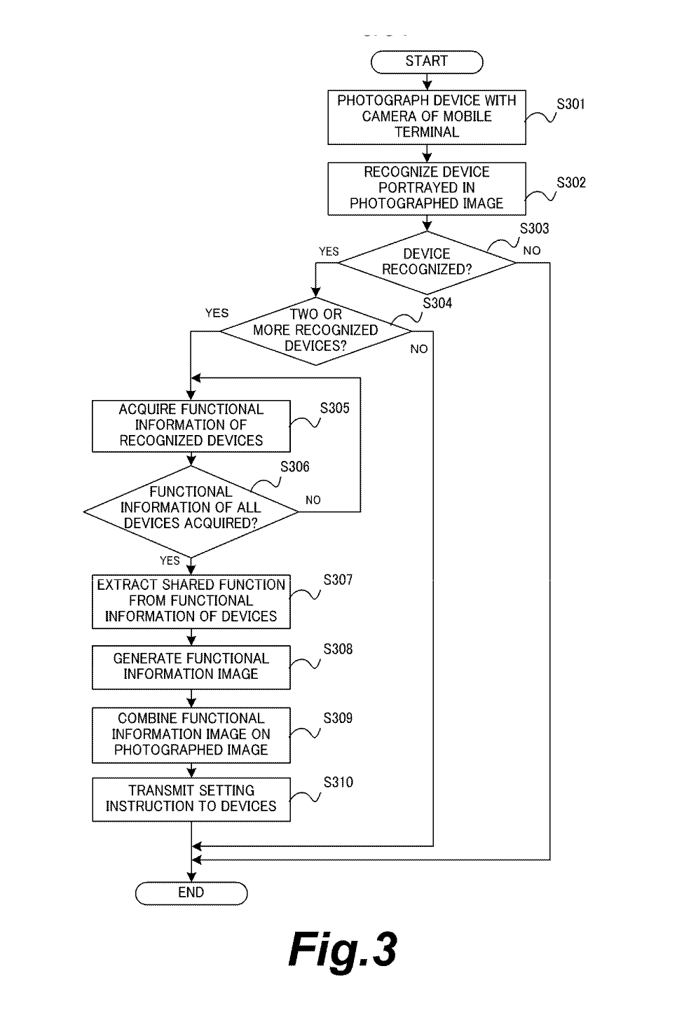

Next, processing for displaying a functional information image of the imaging apparatus 120 and the image display apparatus 100 according to the first embodiment will be described with reference to the flow chart shown in FIG. 3.

### S301

In step S301, the camera 151 of the mobile terminal 150 photographs the image display apparatus 100 and the imaging apparatus 120 as shown in FIG. 2 in response to an operation on the mobile terminal 150 by the user (for example, an operation of pressing a photography button). The camera 151 outputs a photographed image to the image combining unit 158. The image combining unit 158 outputs the photographed image to the display unit 152. Accordingly, an image photographed by the camera 151 is displayed (live display of a photographed image) on a screen of the mobile terminal 150. The camera 151 outputs the photographed image to the device recognizing unit 153.

### S302

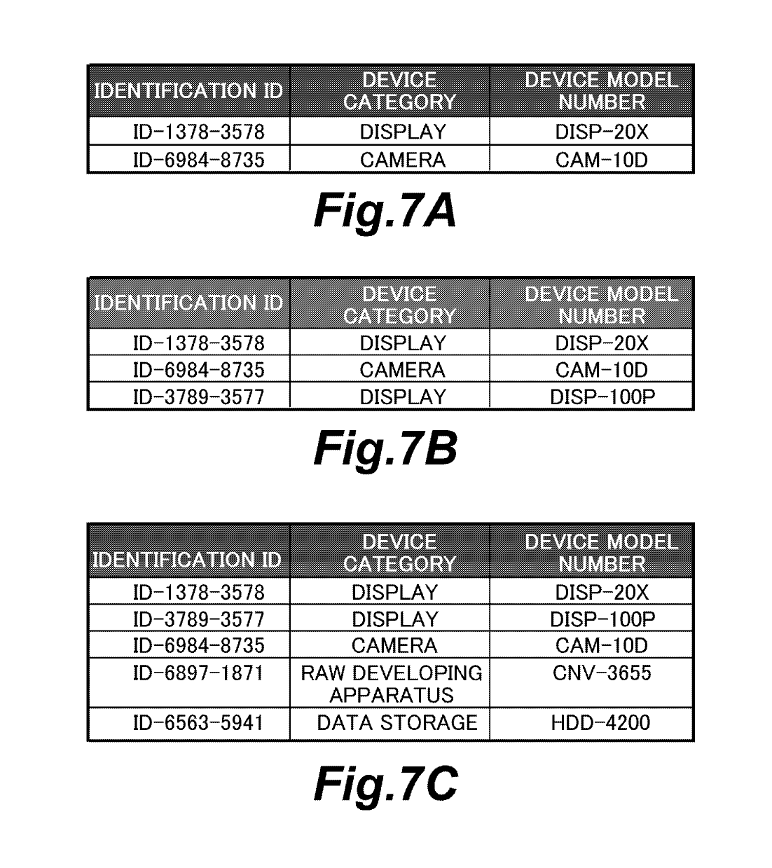

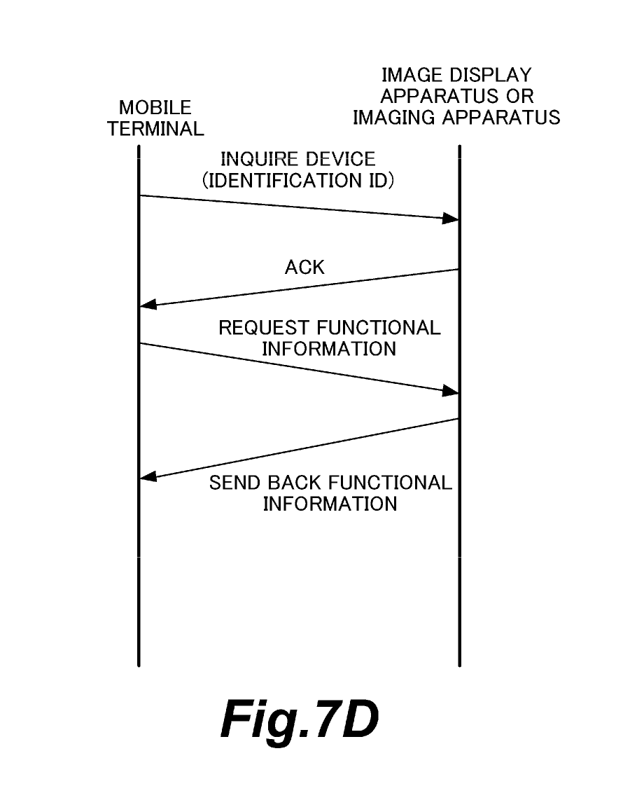

In step S302, the device recognizing unit 153 detects an AR code portrayed in the photographed image and, based on information encoded in the AR code, recognizes a device portrayed in the photographed image. An example of information obtained by an analysis of an AR code is shown in FIG. 7A. It is assumed that information obtained by analyzing the AR code of the image display apparatus 100 is an identification ID “ID-1378-3578” and a model number “DISP-20X”. It is also assumed that information obtained by analyzing the AR code of the imaging apparatus 120 is an identification ID “ID-6984-8735” and a model number “CAM-10D”. The device recognizing unit 153 notifies the functional information acquiring unit 155 of identification information (a list of identification IDs and model numbers) of the respective devices portrayed in the photographed image obtained by analyzing the AR codes.

### S303

Instep S303, the device recognizing unit 153 determines whether devices portrayed in the photographed image have been recognized. When there is a device that cannot be recognized, the processing is terminated. In this case, the mobile terminal 150 maintains a normal state of live display of the photographed image of the camera 151. When the devices have been recognized, the processing advances to step S304.

### S304

In step S304, the device recognizing unit 153 determines whether there are two or more recognized devices. When there is only one recognized device, the processing is terminated. In the example shown in FIG. 2, since there are two recognized devices, the processing advances to step S305.

### S305

In step S305, based on identification information of each device, the functional information acquiring unit 155 acquires functional information of each device.

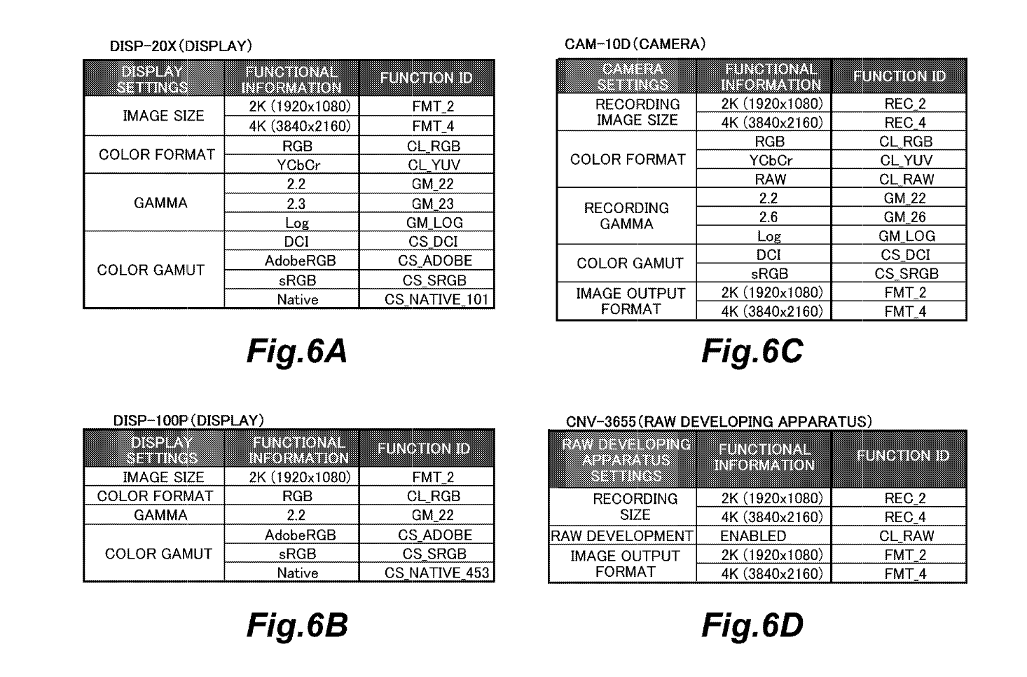

First, processing in which the mobile terminal 150 acquires functional information of the imaging apparatus 120 will be described with reference to a sequence shown in FIG. 7D. The functional information acquiring unit 155 of the mobile terminal 150 broadcast-transmits, via the wireless network 170, the identification ID of the imaging apparatus 120 acquired in step S302 and inquires whether the imaging apparatus 120 exists on the network. Upon receiving the broadcast of the identification ID corresponding to the imaging apparatus 120, the imaging apparatus communicating unit 125 of the imaging apparatus 120 sends back an ACK to the terminal communicating unit 154. Next, the functional information acquiring unit 155 requests the camera setting unit 124 to transmit functional information of the imaging apparatus 120. In response to the acquisition request for functional information, the camera setting unit 124 transmits functional information of the imaging apparatus 120 (model number CAM-10D) shown in FIG. 6C to the functional information acquiring unit 155.

With respect to the image display apparatus 100, the functional information acquiring unit 155 similarly requests, via the terminal communicating unit 154 and the display apparatus communicating unit 105, the display setting unit 104 of the image display apparatus 100 to transmit functional information of the image display apparatus 100. The display setting unit 104 of the image display apparatus 100 transmits the functional information of the image display apparatus 100 (model number DISP-20X) shown in FIG. 6A to the functional information acquiring unit 155.

### S306

In step S306, the functional information acquiring unit 155 determines whether acquisition of functional information of all of the devices recognized in step S302 has been completed. When not completed, a return is made to step S305 to repeat similar processing with respect to devices for which functional information has not been acquired. When acquisition of functional information of all devices has been completed, the functional information acquiring unit 155 collectively transmits the acquired functional information of the respective devices to the functional information processing unit 156. Moreover, while an example has been described in which functional information of all devices is connectively output to the functional information processing unit 156 after acquisition of the functional information of all devices is completed, functional information may be output to the functional information processing unit 156 each time functional information of each device is acquired. In addition, the information (functional information) regarding an image processing function described above is simply an example. There are various types of functional information as shown in FIGS. 6A to 6D. For example, functional information includes information on settings of at least any of a size, a color format, gamma, a color gamut, and permission/inhibition of development of image data in image processing involving at least any of displaying, recording, transmitting, and developing.

### S307

In step S307, based on functional information of each device, the functional information processing unit 156 extracts a common image processing function and outputs the extracted image processing function to the generating unit 157. In the example shown in FIG. 2, functional information of the image display apparatus 100 and the imaging apparatus 120 is as shown in FIGS. 6A and 6C. According to the functional information, common image processing functions are 4K (3840×2160) display, Log gamma, Digital Cinema Initiatives (DCI) color gamut, and the like.

An example of a method of extracting a common image processing function will be described below. It is assumed that individual identification information (a function ID) is assigned to various functions related to image processing of various devices. A same ID is assigned to a common function or a function with cooperation feasibility (permission/inhibition) and, based on a function ID, whether or not image processing executed by each device has a common function or cooperation feasibility can be determined. When there is an image processing function with a same function ID among pieces of functional information of two devices, a determination can be made with respect to the image processing function that the two devices have a common function and are capable of performing a cooperative operation. In other words, the existence of an image processing function of image processing that is common to two devices means that a function with a same function ID is included in the functional information of the two devices. Combining such devices by, for example, connecting the devices using an image cable, the image processing (display, recording, or the like) based on the common image processing function can be executed.

With reference to FIGS. 6A and 6C, for example, a DCI color gamut function ID “CS_DCI” is commonly included in the image display apparatus 100 and the imaging apparatus 120. The imaging apparatus 120 is an image input device and the image display apparatus 100 is an image output device. Therefore, a determination can be made that a combination of the image display apparatus 100 and the imaging apparatus 120 is capable of executing image processing of “image display” with an image processing function of “DCI color gamut”.

The functional information processing unit 156 extracts a function ID commonly included in both pieces of functional information of the image display apparatus 100 and the imaging apparatus 120 as a common image processing function. In the example shown in FIGS. 6A and 6C, function IDs of common image processing functions are “CL_RGB”, “CL_YUV”, “GM_22”, “GM_LOG”, “CS_DCI”, “CS_SRGB”, “FMT_2”, and “FMT_4”. While there may be a large number of common image processing functions as described above, in the first embodiment, a description will be given with a focus on three characteristic common image processing functions of “FMT_4”, “GM_LOG”, and “CS_DCI”. The functional information processing unit 156 transmits information on the extracted common image processing functions to the generating unit 157. Moreover, when the functional information processing unit 156 only extracts a specific image processing function among common image processing functions and outputs the extracted image processing function to the generating unit 157, the user may be asked in advance to specify which of the image processing functions is to be extracted as a common image processing function. Alternatively, the functional information processing unit 156 may transmit all common image processing functions to the generating unit 157.

### S308

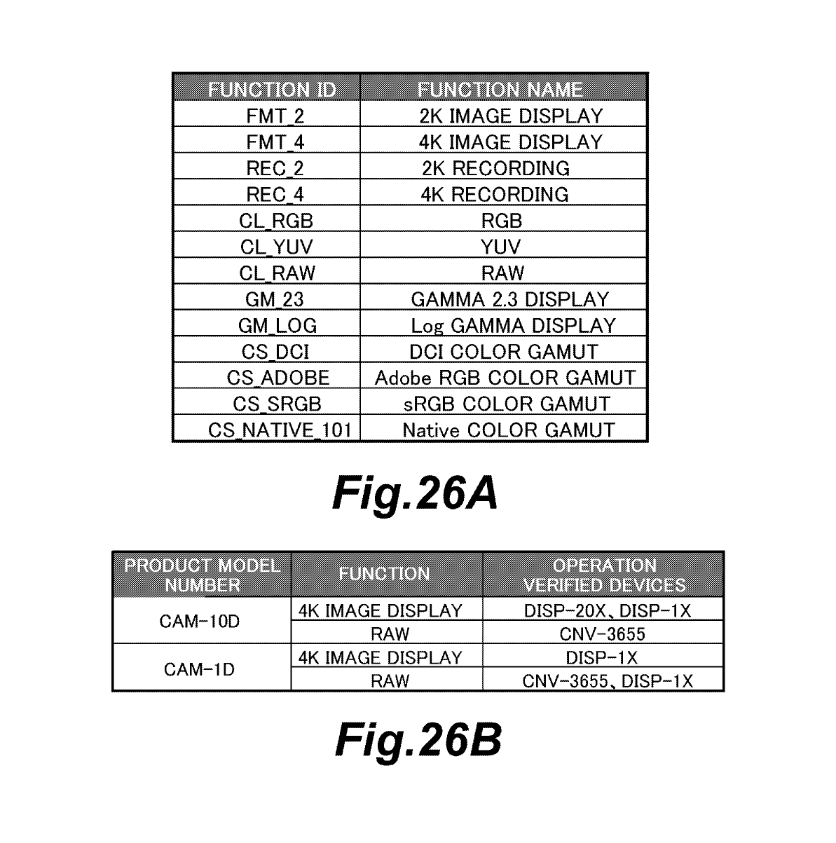

In step S308, the generating unit 157 generates an image indicating information on a common image processing function and outputs the generated image to the image combining unit 158. The generating unit 157 refers to a correspondence relationship determined in advance between function IDs and function names which are names representing the functions shown in FIG. 26A. In addition, a function name corresponding to the function ID of the common image processing function extracted in step S307 is identified and an image indicating information on the common image processing function is constructed using the function name. According to FIG. 26A, the function names corresponding to the function IDs “FMT_4”, “GM_LOG”, and “CS_DCI” are, respectively, “4K image display”, “Log gamma”, and “DCI color gamut”. The generating unit 157 generates an image indicating information on the common image processing functions using these character strings. Based on positional information (XY coordinates) of images of the respective devices in the photographed image acquired from the device recognizing unit 153, the generating unit 157 determines a position of the image representing information on the common image processing functions in the photographed image so as not to overlap with the images of the respective devices.

### S309

In step S309, the image combining unit 158 combines the image representing information on the common image processing functions with the photographed image output from the camera 151 and outputs a combined image to the display unit 152. Accordingly, the functional information image 240 similar to that shown in FIG. 2 is displayed on the screen of the mobile terminal 150.

### S310

In step S310, the device operating unit 159 issues setting instructions to the respective devices so that the devices actually operate at a function setting extracted as a common image processing function.

In this case, it is assumed that the mobile terminal 150 shown in FIG. 2 includes at least any of operation buttons, a keyboard, and a touch panel as input unit for accepting instructions from the user. These input unit are assumed to constitute apart of the functions of the device operating unit 159. In addition, the functional information image 240 displayed on the screen in step S309 is assumed to function as a graphical user interface (GUI) which assists instruction input by the user. For example, by operating an arrow key and an enter key among the operation buttons, the user can input an instruction for selecting at least any of the common image processing functions displayed in the functional information image 240. Alternatively, the user may perform a touch operation on the screen involving touching a position of at least any character string of the common image processing functions displayed in the functional information image 240. Accordingly, an instruction for selecting at least any of the common image processing functions displayed in the functional information image 240 can be input. Based on the information of the image processing function selected by the user, the device operating unit 159 requests the imaging apparatus 120 and the image display apparatus 100 to operate in the selected image processing function.

For example, when the user performs an operation of selecting “DCI color gamut” with respect to the functional information image 240 shown in FIG. 2, the device operating unit 159 requests the imaging apparatus 120 and the image display apparatus 100 to change a color gamut setting to DCI. The camera setting unit 124 of the imaging apparatus 120 having received this request via the wireless network 170 changes a color gamut conversion setting of the image processing unit 123 to DCI. In addition, the display setting unit 104 of the image display apparatus 100 having received this request via the wireless network 170 changes a color gamut conversion setting of the display image control unit 102 to DCI. Due to such processing, the plurality of devices portrayed in the photographed image are set so as to actually perform image processing based on the common image processing function (DCI color gamut).

A case where there are a plurality of combinations of devices with a common image processing function among recognized devices will now be described. In such a case, the generating unit 157 generates a common functional information image for each combination.

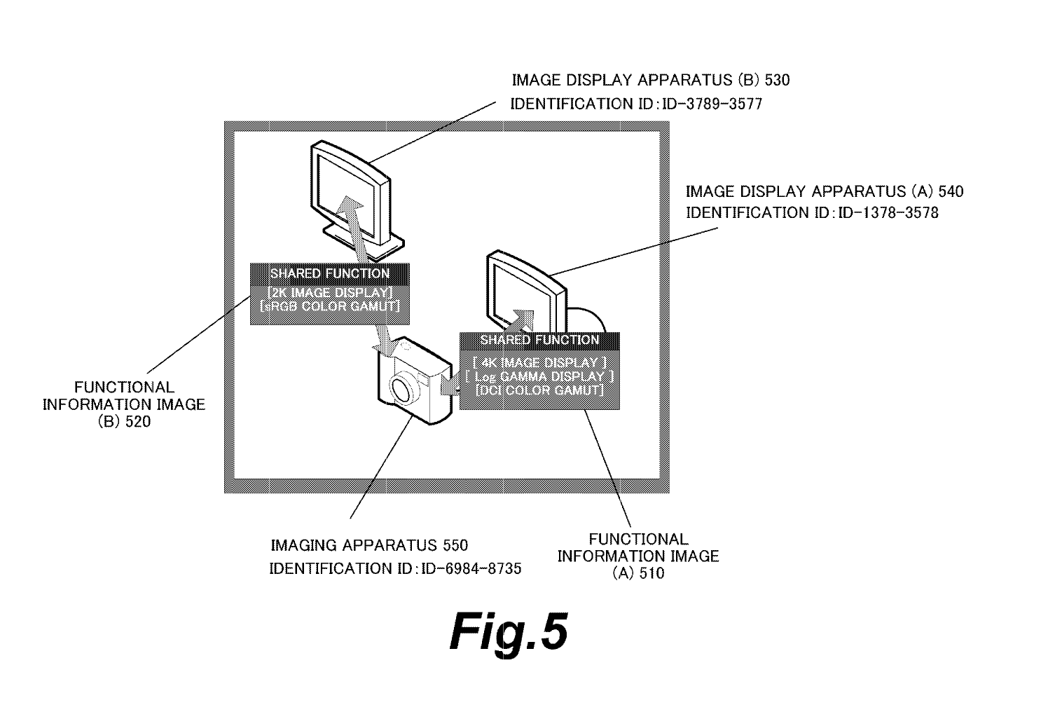

FIG. 5 shows a display example of functional information images when there are two image display apparatuses. Identification IDs of respective devices are shown in FIG. 5. The identification IDs are acquired by analyzing AR codes. FIG. 7B shows a correspondence table between identification IDs and a list of model numbers of the devices. Information on the correspondence table is stored by the device recognizing unit 153 of the mobile terminal 150. The device recognizing unit 153 compares the correspondence table with identification IDs. Accordingly, model numbers of the devices portrayed in the photographed image shown in FIG. 5 are respectively recognized as a model number DISP-20X for an image display apparatus (A) 540, a model number DISP-100P for an image display apparatus (B) 530, and a model number CAM-10D for an imaging apparatus 550. Model number information and the identification ID of each recognized device are transmitted to the functional information acquiring unit 155 and, based on the identification ID, the functional information acquiring unit 155 acquires functional information of each device via the network. Acquired functional information is shown in FIGS. 6A to 6C.

In step S307, based on the functional information shown in FIGS. 6A and 6C, the functional information processing unit 156 extracts “4K (3840×2160) image display”, “Log gamma”, and “DCI color gamut” as common image processing functions of the imaging apparatus 550 and the image display apparatus (A) 540. Subsequently, in step S308, the generating unit 157 generates an image similar to a functional information image (A) 510 shown in FIG. 5.

In addition, in step S307, based on the functional information shown in FIGS. 6B and 6C, the functional information processing unit 156 extracts “2K (1920×1080) image display” and “sRGB color gamut” as common image processing functions of the imaging apparatus 550 and the image display apparatus (B) 530. In step S308, the generating unit 157 generates an image similar to a functional information image (B) 520 shown in FIG. 5.

The image display apparatus (B) 530 cannot execute image processing for 4K display and DCI color gamut display which can be executed by the image display apparatus (A) 540 but can execute image processing for 2K display and sRGB color gamut display. In combination with the imaging apparatus 550, the image display apparatus (B) 530 can execute image processing for 2K display and sRGB color gamut display which are common image processing functions. In combination with the imaging apparatus 550, the image display apparatus (A) 540 can execute image processing for 4K display and DCI color gamut display which are common image processing functions.

Therefore, in the example shown in FIG. 5, among the three devices portrayed in the photographed image, there are two combinations of devices with common image processing functions (the combination of the image display apparatus (A) 540 and the imaging apparatus 550 and the combination of the image display apparatus (B) 530 and the imaging apparatus 550).

For each combination, the generating unit 157 generates an image indicating information on the common image processing functions and combines the image with a photographed image. The screen of the mobile terminal 150 displays the functional information image (A) 510 and the functional information image (B) 520 with contents that differ from those of the functional information image (A) 510. An operation of the device operating unit 159 is to differ depending on which of the functional information image (A) 510 and the functional information image (B) 520 is selected by the user. For example, assuming that the user selects “2K image display” of the functional information image (B) 520, the device operating unit 159 requests the image display apparatus (B) 530 and the imaging apparatus 550 to respectively set the devices so that 2K display can be performed.

As described above, in the first embodiment, each of a plurality of devices is recognized from a photographed image obtained by photographing the plurality of devices with a camera of a mobile terminal such as a tablet, a combination of devices having information on a common image processing function among the recognized devices is obtained, and a functional information image is displayed combined with (superimposed on) the photographed image. By referring to the image, a user can readily discern a combination of devices capable of operating in cooperation among the plurality of devices. Even if the plurality of devices include a device never operated before by the user or a device with functions that the user is unaware of, the user can readily appreciate information on cooperation feasibility and common functions such as which devices should be connected to each other in order to perform desired image processing, resulting in improved convenience.

While an example of using an AR code has been described with respect to a method of recognizing a device according to the first embodiment, this example is not restrictive. For example, other means such as visible light communication can be used. Visible light communication is a type of wireless communication and refers to a technique in which a light source such as a light emitting diode (LED) flickers at high speed and information is transmitted and received through flickering patterns thereof. For example, a method can be used in which information on a device such as identification information is acquired by having a backlight of a display, an LED of an indicator such as a power supply lamp, or the like flicker at high speed and photographing the flickering visible light with an image sensor of a camera of a tablet or the like.

Moreover, while an example of extracting a common image processing function based on a function ID has been described in the first embodiment, a method of extracting a common image processing function is not limited thereto. For example, patterns of device combinations for which a common image processing function may exist can be obtained and stored in advance, in which case a combination of devices having a common image processing function among a plurality of devices portrayed in a photographed image may be obtained by referring to the patterns of device combinations obtained and stored in advance. An example thereof is shown in FIG. 26B. FIG. 26B shows that, for example, a combination of CAM-10D and DISP-20X has 4K image display as a common image processing function. Therefore, if CAM-10D and DISP-20X exist among devices recognized by the device recognizing unit 153, a determination can be made that a combination thereof has a common image processing function. In other words, since a combination having a common image processing function can be obtained without having the functional information processing unit 156 extract a common image processing function based on acquisition of functional information and retrieval of matching function IDs by the functional information acquiring unit 155, processing can be simplified. Furthermore, function IDs such as those shown in FIGS. 6A to 6D need no longer be registered to devices.

Moreover, while an example of recognizing a device using a camera of a mobile terminal has been described in the first embodiment, a device recognizing process can be performed by mounting an AR function to an imaging apparatus. In addition, while an example of displaying a functional information image being combined on a photographed image has been described in the first embodiment, information represented by an image combined on a photographed image is not limited thereto. For example, a manual of a device capable of a cooperative operation may be displayed.

### First Modification

Next, an example will be described in which, in a case where devices included in a photographed image are a plurality of display apparatuses, a combination of display apparatuses having a common image processing function and calibrated such that display characteristics thereof are the same is obtained and a functional information image indicating display apparatuses included in the combination is displayed.

There may be cases where a plurality of displays are used in combination for image diagnosis. For example, a mammographic diagnosis may be made by arranging two displays side by side and comparing an image taken during a previous diagnosis with an image taken during a current diagnosis. With such image diagnosis, in order to ensure accuracy of the diagnosis, not only must functions of the displays match each other but display quality (display characteristics) thereof must also be calibrated to be the same. A state where a plurality of displays have matching display functions and are calibrated so that display characteristics thereof are the same will be referred to as pairing-enabled.

When there are a plurality of displays, it is difficult for a user to visually determine whether or not the displays are pairing-enabled or, in other words, whether or not display characteristics of the respective displays are the same. In consideration thereof, if information indicating whether or not a plurality of displays are pairing-enabled can be displayed on a screen of a mobile terminal as a functional information image, convenience of the user during image diagnosis can be improved. In addition, convenience of the user during image diagnosis can also be improved by displaying information indicating that a plurality of displays become pairing-enabled when appropriately calibrating at least one of the plurality of displays is displayed on a screen of a mobile terminal as a functional information image.

Therefore, the functional information acquiring unit 155 acquires information on an image processing function and information related to a calibration state of each display apparatus recognized from a photographed image. Information related to a calibration state is, for example, information indicating how a relationship between a gradation value and brightness, white balance, gamma characteristics, contrast, or the like is being adjusted. The functional information acquiring unit 155 acquires, from each display apparatus, functional information and calibration information of each display apparatus via the wireless network 170. Based on the information, the functional information processing unit 156 obtains a combination of display apparatuses having a common image processing function and calibrated such that display characteristics are the same among the plurality of recognized display apparatuses and outputs information on the combination to the generating unit 157. The generating unit 157 generates a functional information image indicating which display apparatuses among the recognized display apparatuses are the display apparatuses included in the combination and combines the functional information image with a photographed image.

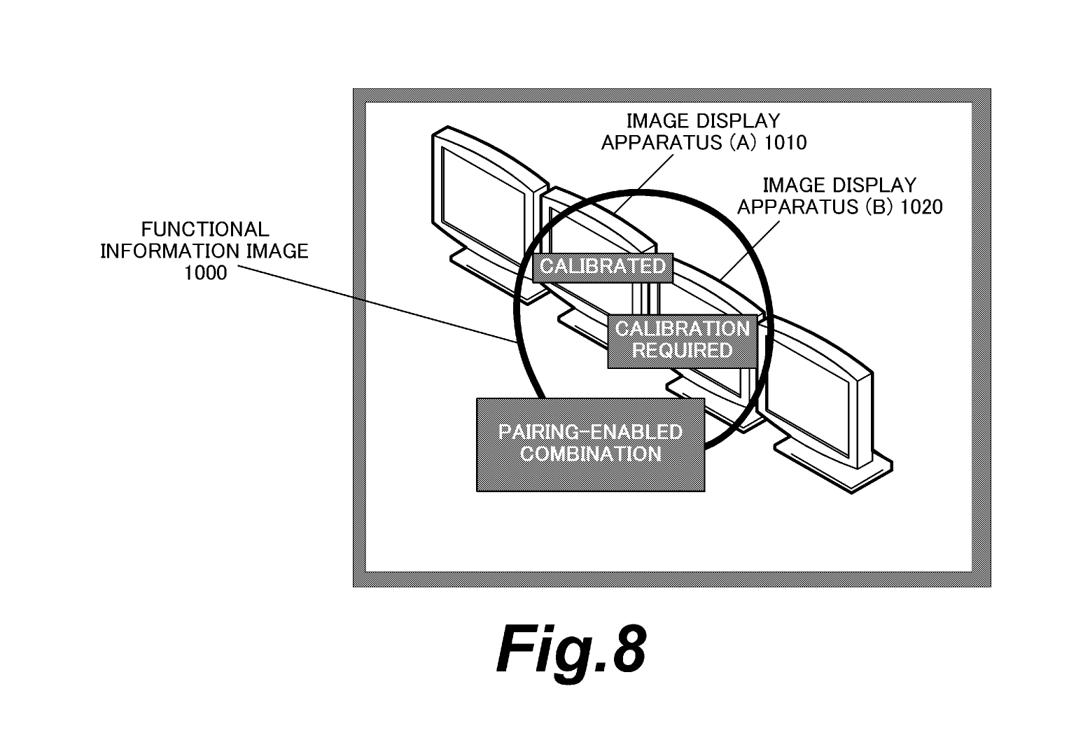

In addition, the functional information processing unit 156 obtains, among the plurality of display apparatuses, a combination of display apparatuses having a common image processing function and enabling display characteristics to be made the same by calibrating at least one display apparatus. The functional information processing unit 156 outputs information on the combination to the generating unit 157. The generating unit 157 generates a functional information image which indicates the display apparatuses related to the combination and which indicates that the display apparatuses become pairing-enabled by calibrating at least one display apparatus, and combines the functional information image with a photographed image. A functional information image 1000 shown in FIG. 8 is an example of a functional information image generated by the generating unit 157. In FIG. 8, the functional information image 1000 shows that an image display apparatus (A) 1010 and an image display apparatus (B) 1020 among a plurality of display apparatuses have a common image processing function and become pairing-enabled by calibrating the image display apparatus (B) 1020. By displaying such a functional information image, convenience of the user when pairing a plurality of displays and performing image diagnosis is improved.

### Second Embodiment

A second embodiment will now be described. In the second embodiment, a specification of a function which a user desires to use is accepted from the user and an image indicating information on a combination of devices having the function specified by the user as a common image processing function is combined with a photographed image and is displayed. Accordingly, the user can readily discern a combination of devices that can be caused to perform image processing in a function desired by the user. A detailed description will now be given.

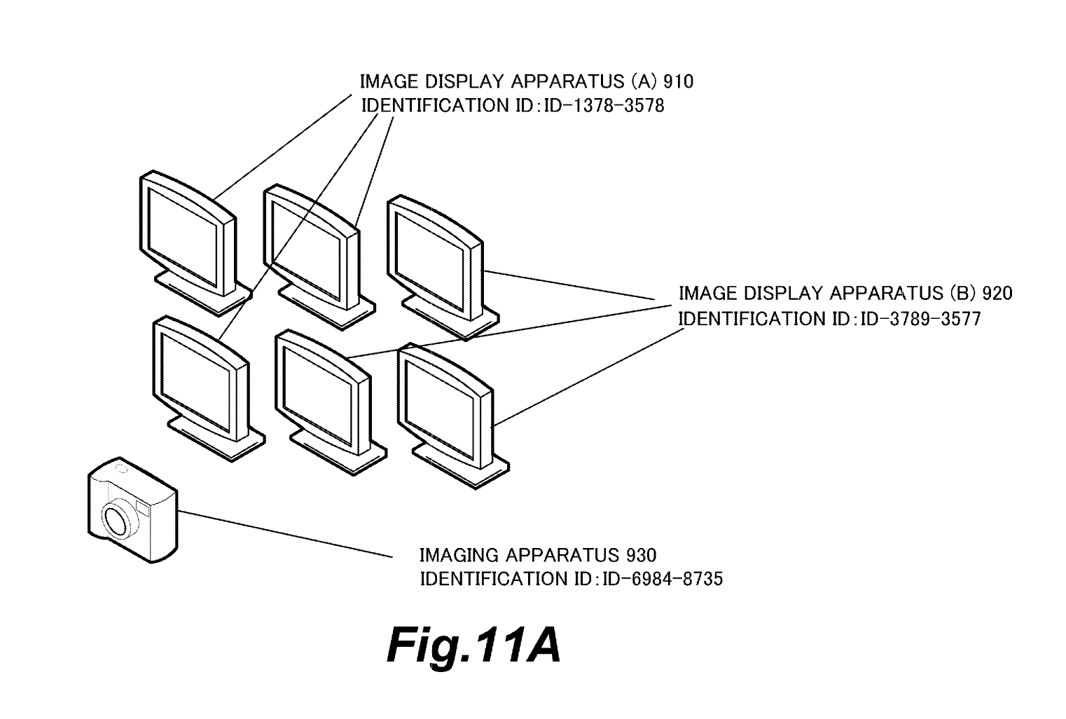

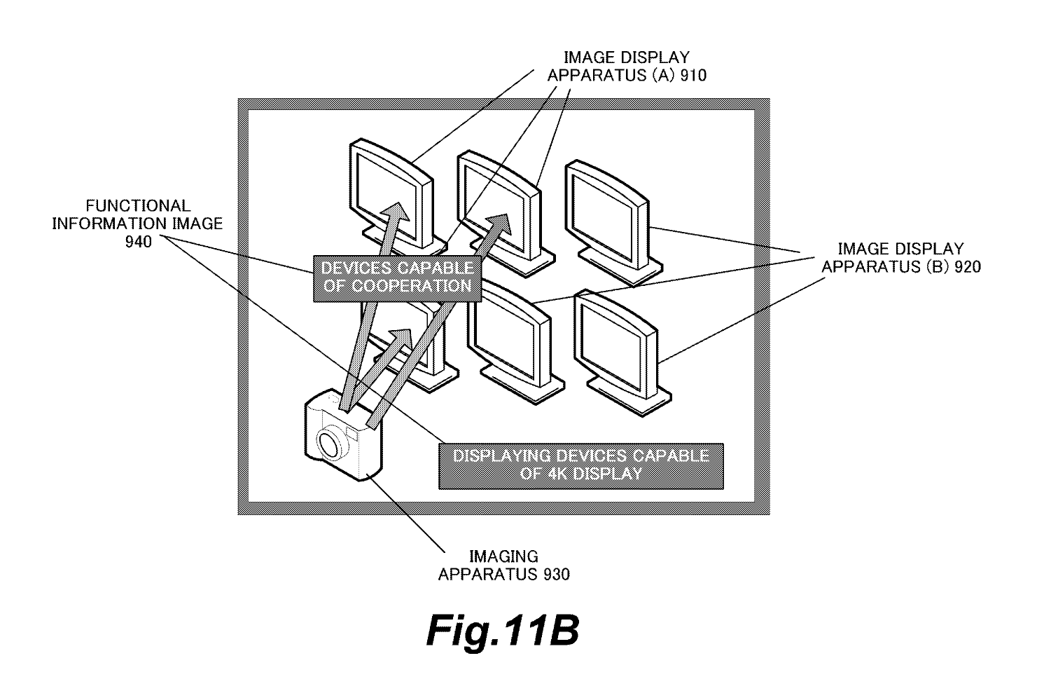

FIG. 11A is a diagram illustrating a display apparatus and a group of devices that are application targets of a control method of the display apparatus according to the second embodiment. In the example shown in FIG. 11A, there are three image display apparatuses (A) 910 which accommodate 4K display and three image display apparatuses (B) 920 which only accommodate 2K display. Based on identification IDs, it is revealed that a model number of the image display apparatus (A) 910 is DISP-20X and that a model number of the image display apparatus (B) 920 is DISP-100P. In addition, there is one imaging apparatus 930 which is capable of outputting 4K and 2K images. A situation will be assumed where the user connects the imaging apparatus 930 with any of the image display apparatuses and desires to display an image to be output from the imaging apparatus 930 with the image display apparatus at a desired setting (for example, 4K).

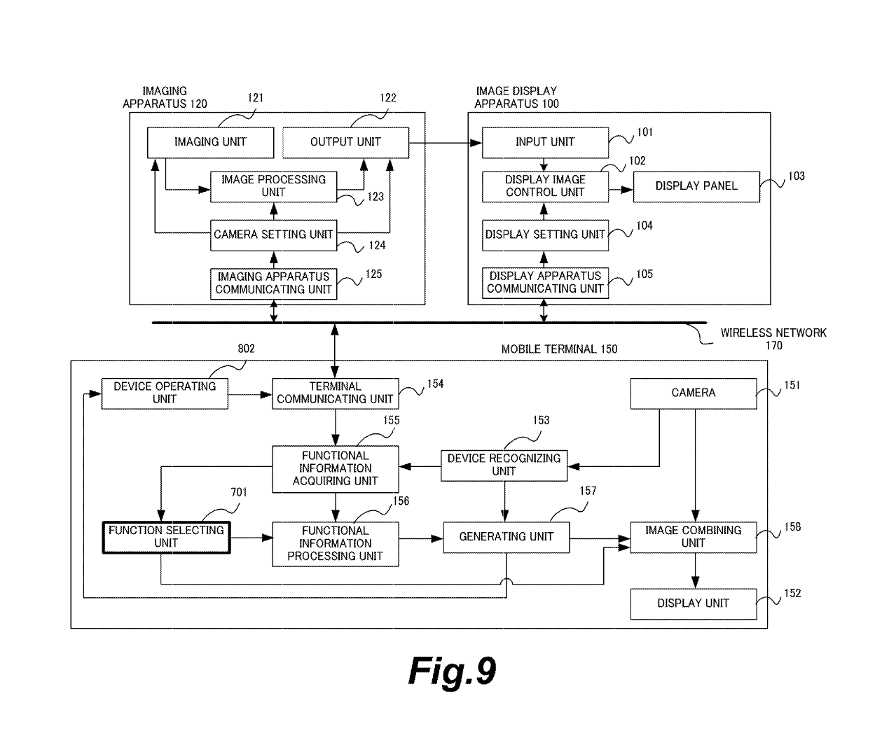

FIG. 9 is a block diagram showing a functional configuration of the group of devices described above according to the second embodiment. A difference from the first embodiment is that a function selecting unit 701 has been added to the mobile terminal 150.

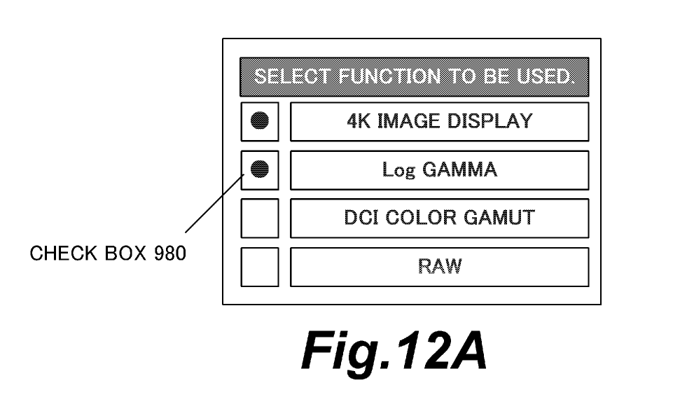

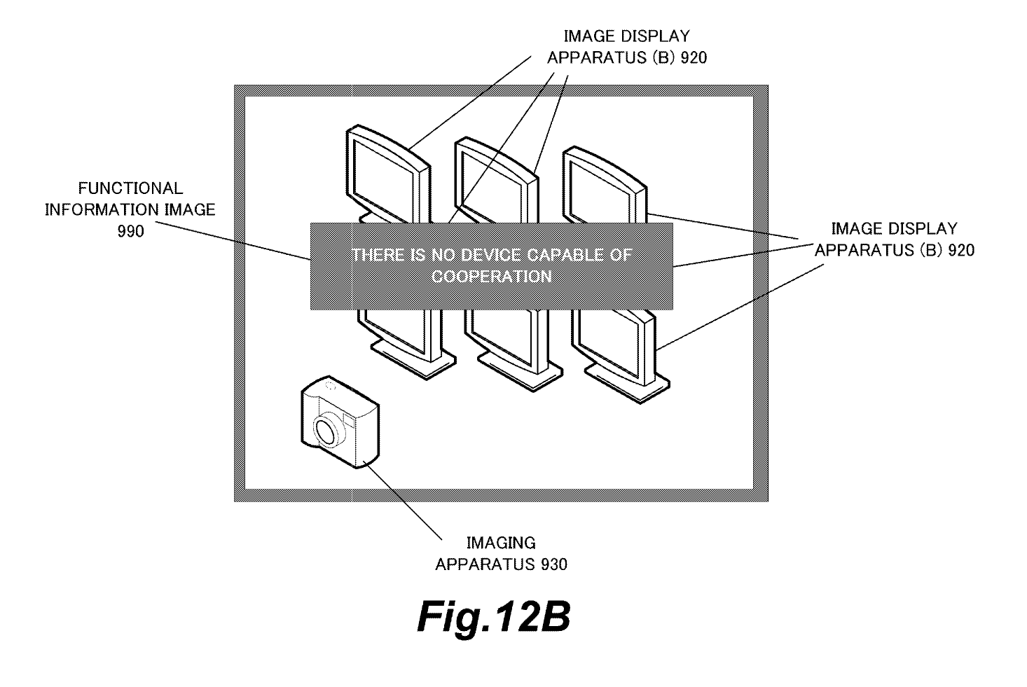

The function selecting unit 701 accepts an input of an instruction that specifies a desired image processing function from the user. The function selecting unit 701 displays a function selection screen similar to that shown in FIG. 12A and causes the user to select a function that the user wishes to use.

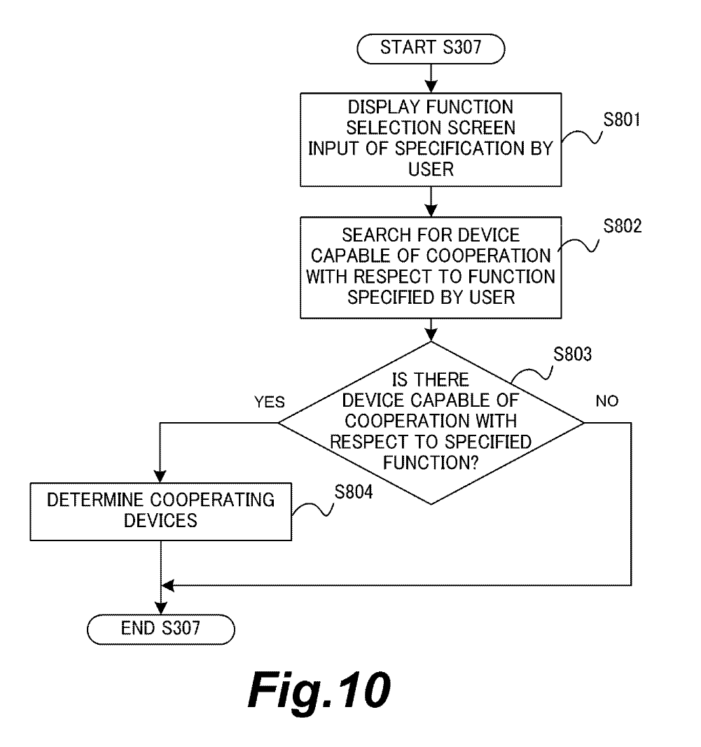

Processing with respect to recognized devices for obtaining a combination of devices having an image processing function specified by the user as a common image processing function will be described with reference to the flow chart shown in FIG. 10. The flow chart shown in FIG. 10 presents details of contents of processing in step S307 in which a common image processing function is extracted based on functional information of respective devices in the flow chart shown in FIG. 3 according to the first embodiment. It is assumed that processing has advanced to step S306 and recognition of all devices photographed by the camera 151 has been completed.

### Step S801

First, in step S801, the function selecting unit 701 accepts a user operation for specifying an image processing function which the user desires to use when displaying an image output from the imaging apparatus 930 on an image display apparatus. Specifically, the function selecting unit 701 performs processing to display a graphical user interface (GUI) of a function selection screen such as that shown in FIG. 12A for selecting a function which the user desires to use on the screen of the mobile terminal 150. The function selecting unit 701 generates an image constituting the GUI of the function selection screen and outputs the image to the image combining unit 158. In this case, the function selecting unit 701 generates a function selection screen based on functional information (FIG. 6C) of the imaging apparatus 930.

While the example shown in FIG. 12A represents a case where options on the function selection screen are narrowed down to four characteristic functions among the functions of the imaging apparatus 930 shown in FIG. 6C, the options to be displayed on the function selection screen are not limited thereto. All of the functions included in the functional information of the imaging apparatus 930 may be displayed or functions less than the four illustrated functions may be displayed as options. The user can input an instruction for specifying a desired function by operating buttons or a touch panel provided on the mobile terminal 150 while viewing the GUI of the function selection screen. It is assumed that input unit such as the buttons and the touch panel are included in the function selecting unit 701 as a part of its functions.

As shown in FIG. 12A, the GUI of the function selection screen includes a check box 980 corresponding to a function of each option and is configured such that a check mark is to be displayed in the check box 980 corresponding to the function specified by the user. Moreover, a configuration of a GUI for causing the user to specify a desired function is not limited thereto.

In this case, it is assumed that the user has specified 4K image display and Log gamma as desired functions when performing image display. As shown in FIG. 12A, check marks are displayed in the check boxes 980 corresponding to 4K image display and Log gamma. As described in the first embodiment, function IDs of the specified functions are, respectively, “FMT_4” and “GM_LOG”. The function selecting unit 701 notifies the functional information processing unit 156 of the functional information specified by the user.

### Step S802

In step S802, the functional information processing unit 156 searches for devices capable of cooperation with respect to the image processing function specified by the user. In other words, the functional information processing unit 156 searches for an image display apparatus which forms, with the imaging apparatus 930, a combination having the image processing function specified by the user as a common image processing function among the plurality of recognized image display apparatuses. In this case, the image processing functions specified by the user are 4K image display and Log gamma. Based on functional information of the plurality of recognized image display apparatuses, the functional information processing unit 156 searches for an image display apparatus having the function IDs “FMT4” and “GM_LOG” which correspond to the image processing functions specified by the user. Referring to the functional information of the image display apparatus (A) 910 shown in FIG. 6A and the functional information of the image display apparatus (B) 920 shown in FIG. 6B, it is the image display apparatus (A) 910 which has the function IDs “FMT4” and “GM_LOG”.

The functional information processing unit 156 determines a combination of the imaging apparatus 930 and the image display apparatus (A) 910 as a combination of devices having the image processing functions specified by the user as common image processing functions. In other words, the image display apparatus (A) 910 is determined to be capable of cooperating with the imaging apparatus 930 with respect to the image processing functions specified by the user. On the other hand, the image display apparatus (B) 920 does not have the function IDs of 4K display and Log gamma. Therefore, the functional information processing unit 156 determines that the image display apparatus (B) 920 is not a device which, in combination with the imaging apparatus 930, has the image processing functions specified by the user as common image processing functions. In other words, the image display apparatus (B) 920 is determined to be incapable of cooperating with the imaging apparatus 930 with respect to the image processing functions specified by the user.

### Step S803

In step S803, when it is determined that there is no device capable of cooperation (NO), in step S308 following step S307, the generating unit 157 generates a functional information image 990 such as that shown in FIG. 12B which indicates that there is no device capable of cooperation and outputs the functional information image 990 to the image combining unit 158. The functional information image 990 indicates that there is no combination of devices having a function specified by the user as a common image processing function. When there is a device capable of cooperation (YES), processing advances to step S804.

### Step S804

In step S804, the functional information processing unit 156 determines a combination of devices (cooperating devices) having the image processing function specified by the user as a common image processing function. In this case, the functional information processing unit 156 determines a combination of the imaging apparatus 930 and the image display apparatus (A) 910 as cooperating devices and notifies the generating unit 157 of information on the cooperating devices. In step S308 following step S307, the generating unit 157 generates an image indicating information on the cooperating devices and outputs the image to the image combining unit 158. Accordingly, as shown in FIG. 11B, a functional information image 940 indicating that the imaging apparatus 930 and the image display apparatus (A) 910 are capable of cooperation is displayed in a vicinity of the devices. The functional information image 940 is an image indicating that the imaging apparatus 930 and the image display apparatus (A) 910 are a combination of devices having 4K image display and Log gamma, which are image processing functions specified by the user, as common image processing functions. Due to the functional information image 940, the user can learn which of the recognized devices are devices included in a combination of devices which has a specified image processing function as a common image processing function.

As described above, in the second embodiment, a combination of devices having a function specified by the user as a common image processing function is obtained, a functional information image indicating the combination is combined with a photographed image, and the combined image is displayed on the screen of the mobile terminal 150. Accordingly, the user can readily learn which devices can be combined to make a desired function usable.

### Third Embodiment

A third embodiment will now be described. In the third embodiment, an example will be shown in which a functional information image indicating information on a combination of devices capable of reproducing image data recorded in an imaging apparatus is displayed being combined on a photographed image. The third embodiment is an embodiment capable of improving convenience of a user in a state where, for example, there is an apparatus storing image data which the user wishes to view but the user is unsure as to which device should be used to reproduce and view the image data. In the second embodiment, an example is described in which, when an image processing function specified by the user is the display of 4K and Log gamma images output from an imaging apparatus, a combination of devices having the specified image processing function as a common image processing function is obtained and displayed. In the third embodiment, an example will be described in which, when image processing functions specified by the user is developing and display of 4K RAW data, a combination of devices having the specified image processing functions as common image processing functions is obtained and displayed.

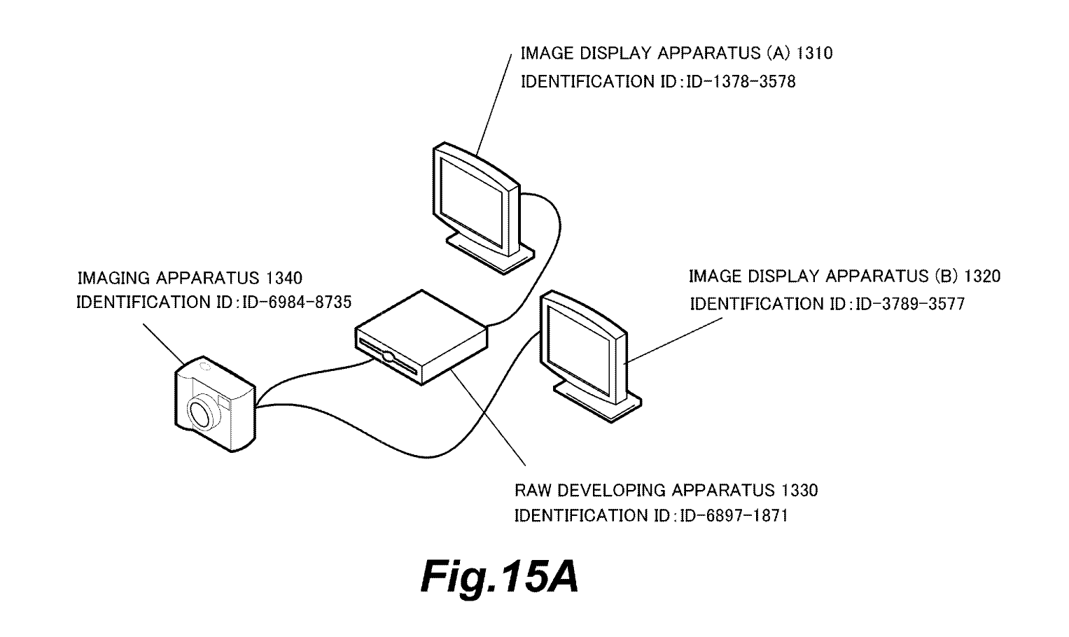

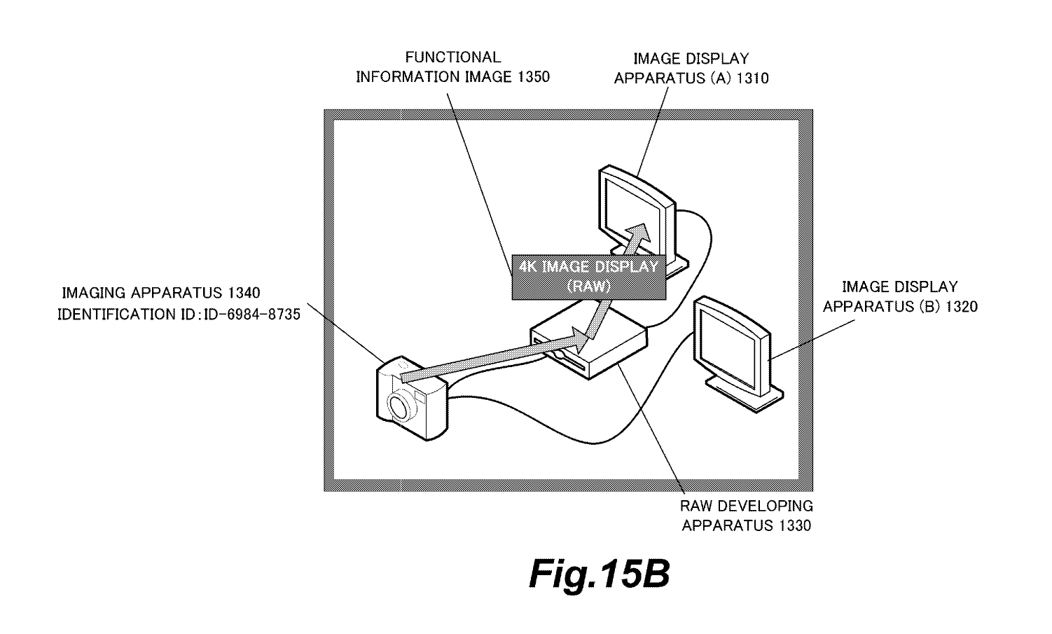

FIG. 15A shows a display apparatus and a group of devices that are application targets of a control method of the display apparatus according to the third embodiment. The group of devices includes an image display apparatus (A) 1310, an image display apparatus (B) 1320, a RAW developing apparatus 1330, and an imaging apparatus 1340, which are respectively connected by image cables. The imaging apparatus 1340 stores 4K image (3840×2160) data (RAW data) with a RAW format. In order to display the 4K RAW data, the RAW data stored in the imaging apparatus 1340 must be read and developed and, further, output to an image display apparatus capable of displaying 4K images.

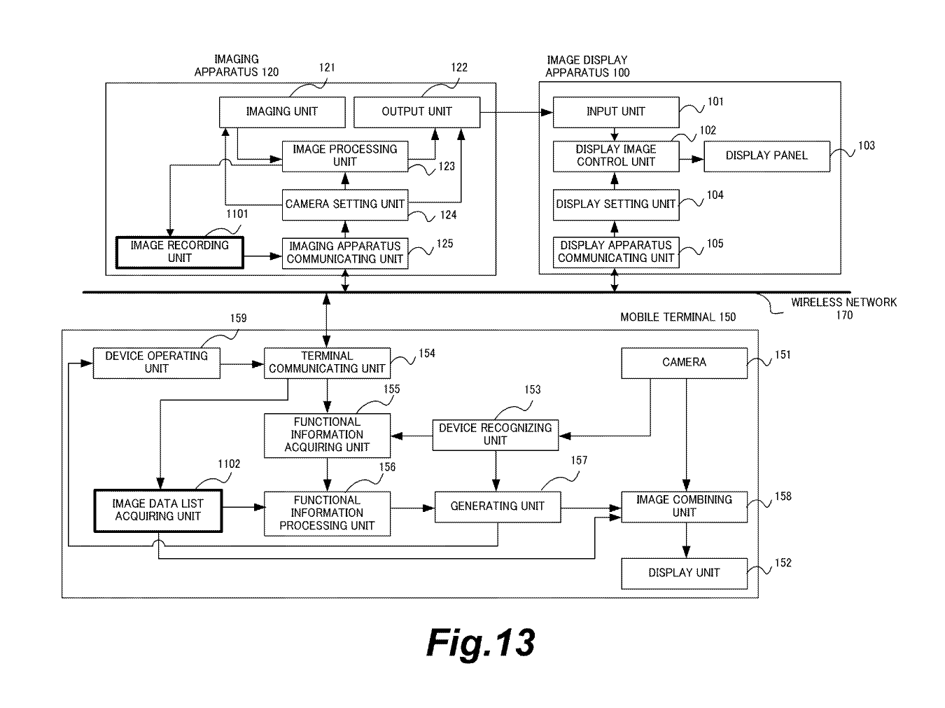

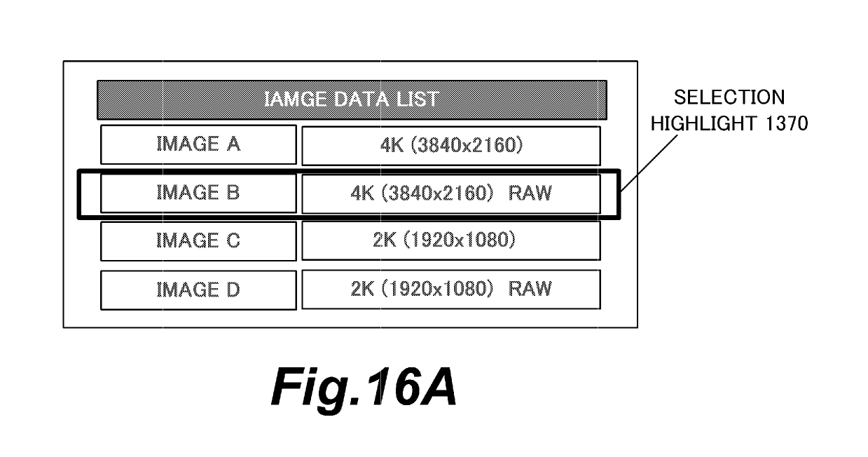

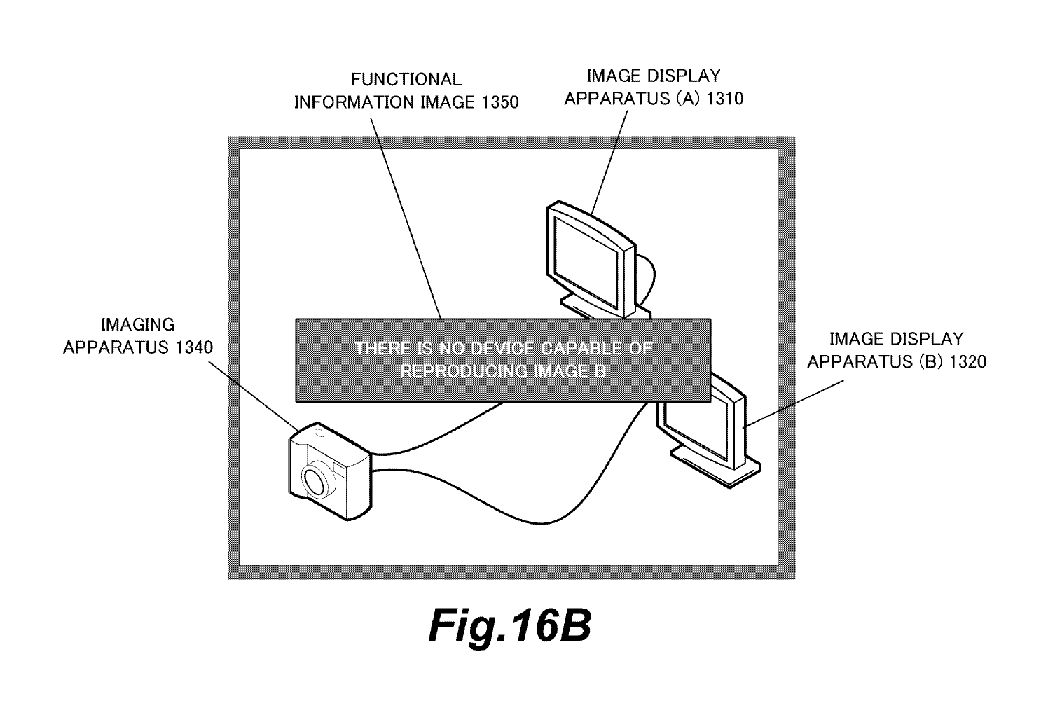

FIG. 13 is a block diagram showing a functional configuration of the group of devices described above. A difference between a configuration of the group of devices shown in FIG. 13 and the configuration of the group of devices described in the first embodiment is an image recording unit 1101 and an image data list acquiring unit 1102. The image recording unit 1101 is a recording medium in which image data photographed by the imaging apparatus 120 is recorded. It is assumed that the image recording unit 1101 records four pieces of image data of images A to D as shown in FIG. 16A. The image recording unit 1101 also records a list of image data. The image data list acquiring unit 1102 of the mobile terminal 150 acquires, via the wireless network 170, the list of the image data and information on formats of the image data recorded in the imaging apparatus 120.

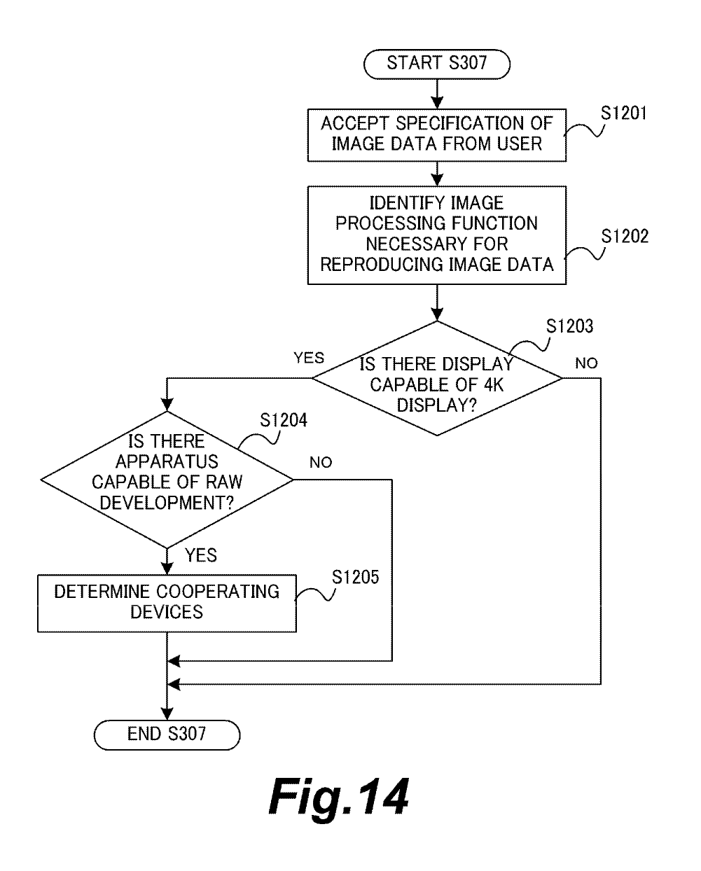

Processing for displaying a functional information image according to the third embodiment will be described with reference to the flow chart shown in FIG. 14. The flow chart shown in FIG. 14 presents details of contents of processing in step S307 in which information on a common image processing function is extracted from functional information of respective devices in the flow chart shown in FIG. 3.

### S1201

In step S1201, the image data list acquiring unit 1102 performs processing for causing an image data selection screen such as that shown in FIG. 16A to be displayed on the display unit 152 of the mobile terminal 150. The image data list acquiring unit 1102 generates an image constituting the GUI of the image data selection screen and outputs the image to the image combining unit 158. By having the GUI displayed, the image data list acquiring unit 1102 accepts a user operation for specifying image data to be reproduced. The user can input an instruction for specifying image data to be reproduced by operating buttons or a touch panel provided on the mobile terminal 150 while viewing the GUI of the image data list. It is assumed that input unit such as the buttons and the touch panel are included in the image data list acquiring unit 1102 as a part of its functions.

The image data list acquiring unit 1102 acquires, via the wireless network 170, the image data list from the image recording unit 1101 of the imaging apparatus 120 and performs processing for displaying an image data selection screen. In this case, it is assumed that the user has performed an operation for selecting (specifying) the image B on the image data selection screen. As shown in FIG. 16A, the image B is 4K (3840×2160) RAW data. The image data list acquiring unit 1102 notifies the functional information processing unit 156 of format information of the selected image data.

### S1202

In step S1202, the functional information processing unit 156 identifies an image processing function necessary for reproducing the image data selected (specified) by the user based on format information of the image data specified by the user and acquired from the image data list acquiring unit 1102. Based on the necessary image processing function and functional information of each recognized device, the functional information processing unit 156 determines whether there is a combination of devices capable of reproducing the specified image data (the image B) among the plurality of recognized devices as shown in the following steps. In other words, the functional information processing unit 156 determines whether there is a combination of devices having an image processing function of reproducing the image B as a common image processing function. Since the image B is 4K RAW data, the image processing functions related to reproduction of the image B are 4K image display and RAW development.

### S1203

In step S1203, the functional information processing unit 156 determines whether there is an image display apparatus having a 4K image display function among the recognized devices. The functional information processing unit 156 searches for an image display apparatus having a function with a function ID “FMT_4” in a list of recognized devices (shown in FIG. 7C). Referring to functional information (shown in FIGS. 6A to 6D) of the respective recognized devices, it is revealed that the image display apparatus (A) 1310 (model number DISP-20X) has a 4K image display function. In this case, the functional information processing unit 156 determines that there is an image display apparatus capable of 4K display among the recognized devices (YES) and advances to step S1204. When there is no image display apparatus capable of 4K display among the recognized devices (NO), the processing of the present flow chart is terminated. In this case, the functional information processing unit 156 requests the generating unit 157 to display a functional information image 1350 indicating that “there is no device capable of reproducing image B” such as that shown in FIG. 16B.

### S1204

In step S1204, the functional information processing unit 156 determines whether there is a device having a RAW data developing function among the recognized devices. The functional information processing unit 156 searches for a device having a function with a function ID “CL_RAW” in the list of recognized devices (shown in FIG. 7C). Referring to functional information (shown in FIGS. 6A to 6D) of the respective recognized devices, it is revealed that the RAW developing apparatus 1330 (model number CNV-3655) has a RAW data developing function. Therefore, in this case, the functional information processing unit 156 determines that there is a device having a RAW data developing function among the recognized devices (YES) and advances to step S1205. On the other hand, when there is no device having a RAW data developing function (NO), the functional information processing unit 156 requests the generating unit 157 to display a functional information image 1350 such as that shown in FIG. 16B.

Moreover, contents of processing of steps S1203 and S1204 represent an example of a case where image processing functions specified by the user are 4K image display and RAW development and are not limited to the example described above. Contents of processing of steps S1203 and S1204 differ according to the image processing functions specified by the user.

### S1205

In step S1205, the functional information processing unit 156 determines a combination of devices (cooperating devices) having image processing functions necessary for reproducing image data B as specified by the user as common image processing functions. In this case, the functional information processing unit 156 determines a combination of the imaging apparatus 1340, the image display apparatus (A) 1310, and the RAW developing apparatus 1330 as cooperating devices. The functional information processing unit 156 notifies the generating unit 157 of information on the cooperating devices. In step S308 following step S307, the generating unit 157 generates an image indicating information on the cooperating devices and outputs the image to the image combining unit 158. Accordingly, as shown in FIG. 15B, an image indicating information on the cooperating devices (the functional information image 1350) is displayed in the photographed image. Arrows constituting an image of the functional information image 1350 indicate a pathway of a flow of an image involving reading 4K RAW data from the imaging apparatus 1340, developing the data with the RAW developing apparatus 1330, and displaying the data with the image display apparatus (A) 1310. Due to the functional information image 1350, the user can learn which of the recognized devices are devices necessary for reproducing the specified image data and convenience is improved.

As described above, in the third embodiment, based on a standard of image data of which reproduction is specified by the user, a combination of devices capable of reproducing the image data is obtained, a functional information image indicating the combination is combined with a photographed image, and the combined image is displayed on the screen of the mobile terminal 150. Accordingly, the user can readily learn which devices can be combined to reproduce the specified image.

### Fourth Embodiment

A fourth embodiment will now be described. The fourth embodiment represents an example in which, when there is no combination of devices capable of reproducing the image data specified by the user in the third embodiment, an image indicating information on a candidate device which enables the image data to be reproduced by being combined with an existing device is displayed combined on a photographed image.

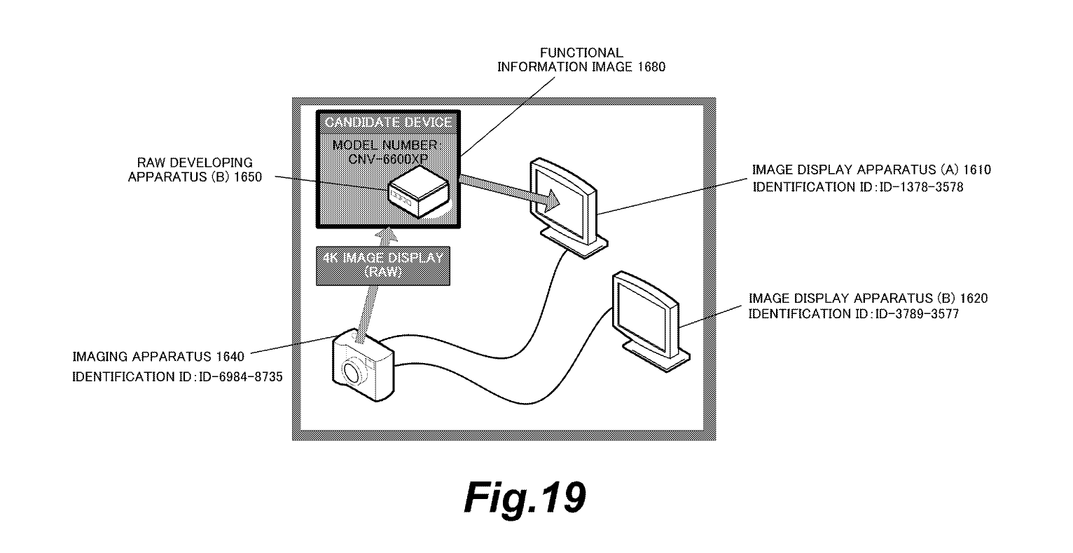

FIG. 19 shows a display apparatus and a group of devices that are application targets of a control method of the display apparatus according to the fourth embodiment. The group of devices includes an image display apparatus (A) 1610, an image display apparatus (B) 1620, and an imaging apparatus 1640, which are respectively connected by image cables. A difference from the third embodiment is that the RAW developing apparatus 1330 is not provided.

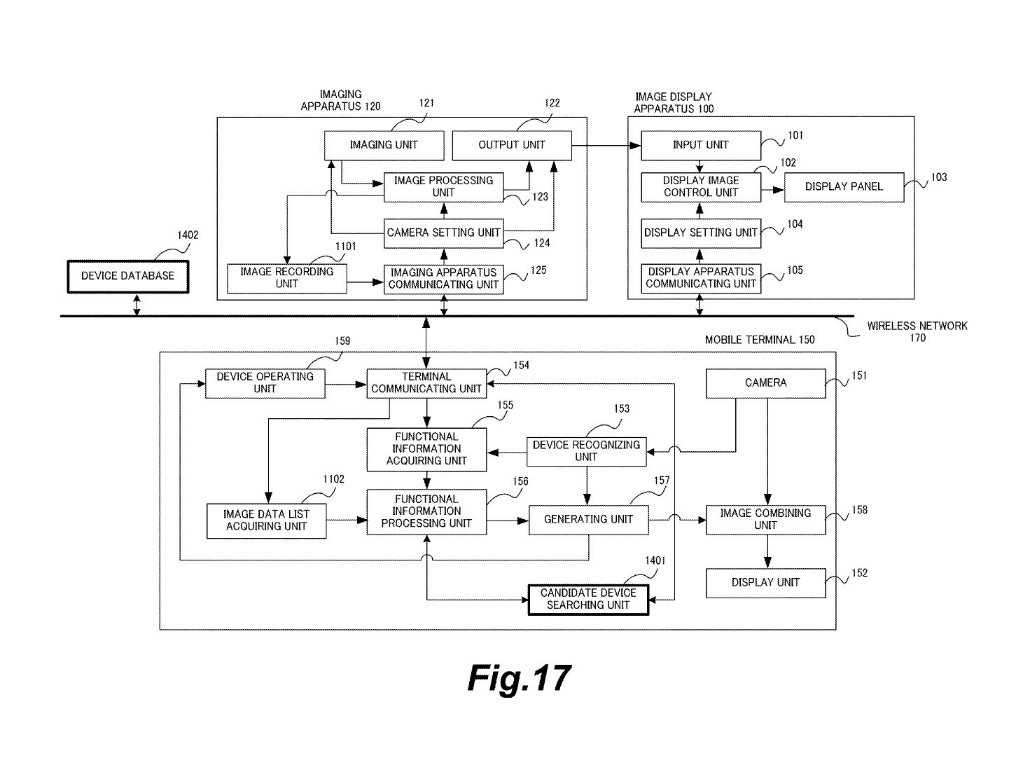

FIG. 17 is a block diagram showing a functional configuration of the group of devices described above. A difference between a configuration of the group of devices shown in FIG. 17 and the configuration of the group of devices described in the third embodiment is a candidate device searching unit 1401 and a device database 1402.

The candidate device searching unit 1401 is third acquiring unit which searches in the device database 1402 in response to a device search request made by the functional information processing unit 156 and acquires information on a candidate device satisfying conditions requested by the functional information processing unit 156.

The device database 1402 is a server on the network and a storage apparatus which stores model numbers and information on image processing functions of prescribed devices.

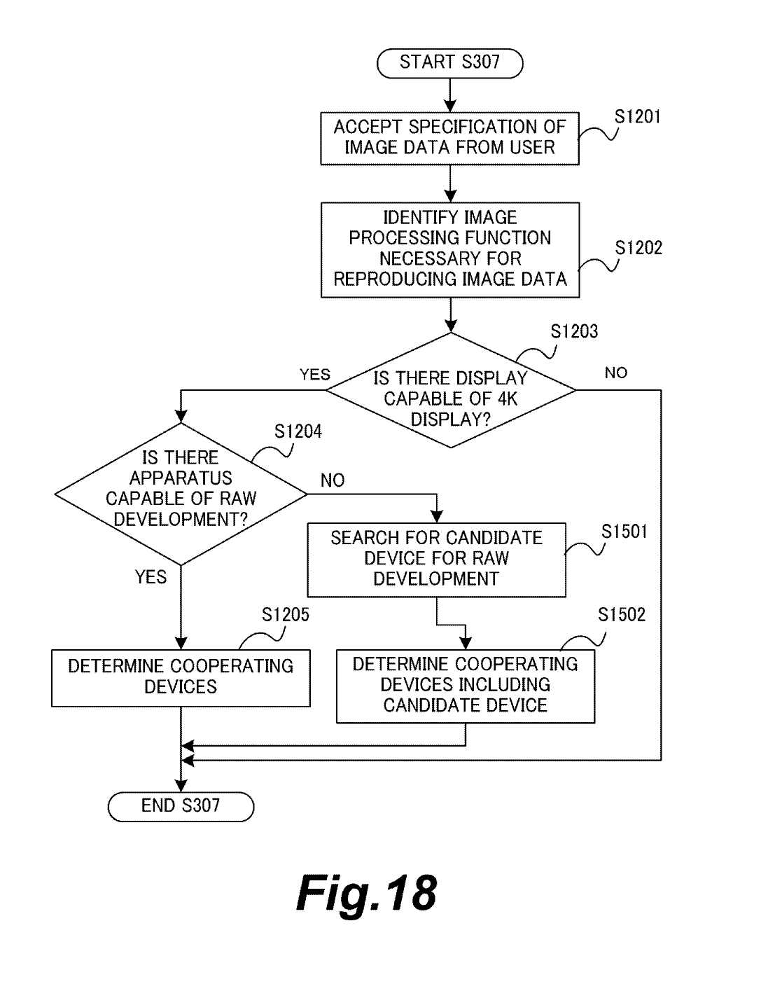

Processing for displaying a functional information image according to the fourth embodiment will be described with reference to the flow chart shown in FIG. 18. A difference between the flow chart shown in FIG. 18 and the flow chart shown in FIG. 14 of the third embodiment is that, when a determination is made in step S1204 that there is no device capable of RAW development, the processing advances to step S1501. In step S1501, as will be described later, a candidate device capable of RAW development is searched and, in following step S1502, processing is performed for determining cooperating devices including the searched candidate device and displaying information on the cooperating devices on a screen of a mobile terminal. Detailed descriptions of processing already described in the third embodiment will be omitted.

### S1501

In step S1501, the functional information processing unit 156 requests the candidate device searching unit 1401 to search for a device capable of RAW development from the device database 1402. The candidate device searching unit 1401 accesses the device database 1402 and acquires information on a device capable of RAW development via the wireless network 170. The candidate device searching unit 1401 searches for a device having a function ID “CL_RAW” from the device database and outputs information on a searched candidate device to the functional information processing unit 156. In this case, it is assumed that the candidate device discovered by the search is a RAW developing apparatus with a model number “CNV-6600XP”. A candidate device is a device which, by being combined with an existing device, would have image processing functions necessary for reproducing image data specified by the user as common image processing functions.

### S1502

In step S1502, the functional information processing unit 156 determines a combination of devices (cooperating devices) which has image processing functions necessary for reproducing the image data specified by the user as common image processing functions and which includes the candidate device. In this case, the functional information processing unit 156 determines a combination of the image display apparatus (A) 1610, the imaging apparatus 1640, and a RAW developing apparatus (B) 1650 that is the candidate device as cooperating devices. The functional information processing unit 156 notifies the generating unit 157 of information on the cooperating devices. The generating unit 157 generates an image indicating information on the cooperating devices and outputs the image to the image combining unit 158. Accordingly, as shown in FIG. 19, an image indicating information on the cooperating devices (a functional information image 1680) is displayed in the photographed image. Due to the functional information image 1680, the user can readily learn that, while there is no device capable of reproducing the specified image data among recognized existing devices, the specified image data can be reproduced with the RAW developing apparatus (B) 1650 that is the candidate device.

As described above, in the fourth embodiment, based on image data of which reproduction is specified by a user, when there is no combination of devices (cooperating devices) capable of reproducing the image data, by displaying a candidate device as a functional information image, the user can readily be informed of means for reproducing the image data.

Moreover, even in a case where there is no device having a function specified by a user in the second embodiment, information on a candidate device may be displayed by a functional information image. For example, a case where the user has specified 4K and Log gamma as functions related to image display has been exemplified in the second embodiment. When a combination of devices including the imaging apparatus 930 which has these functions as common image processing functions does not exist (NO in 5803 in FIG. 10), information on an image display apparatus having 4K image display and Log gamma display as functions is searched from the device database 1402. When such an image display apparatus is discovered by the search, the device may be considered a candidate device, in which case a functional information image including information on the candidate device may be generated and combined with a photographed image to be presented to the user.

### Fifth Embodiment

A fifth embodiment will now be described. The fifth embodiment represents an example in which, with respect to a combination of a plurality of devices having a common image processing function, settings of the plurality of devices are repetitively acquired and monitored, and when a change in settings of the image processing function occurs in any of the devices, a display notifying the change is performed.

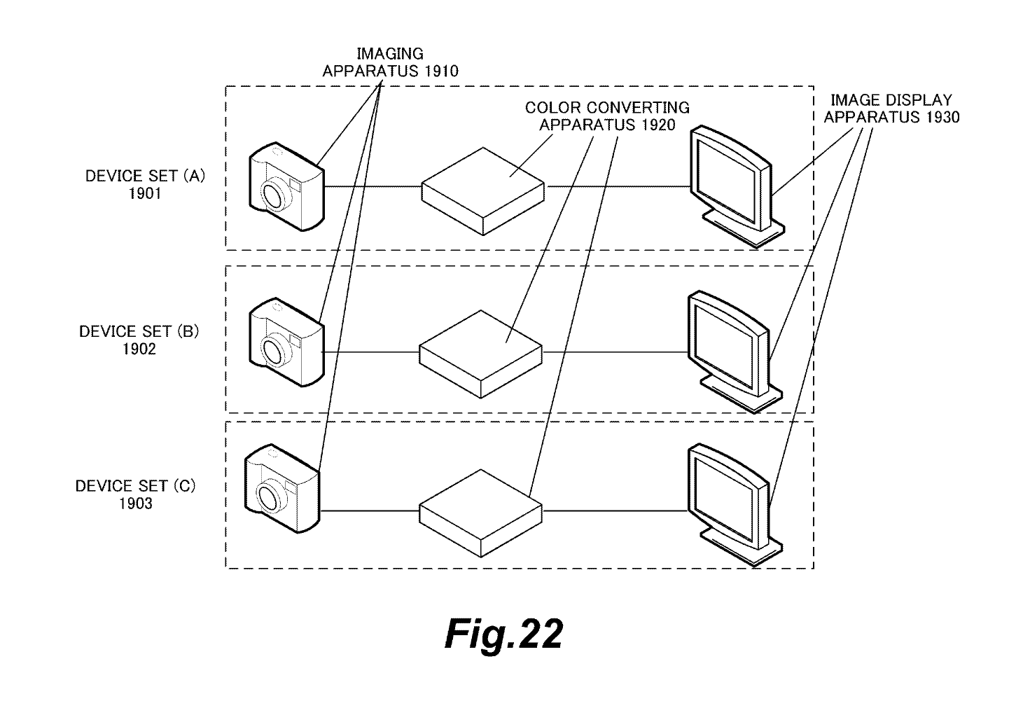

FIG. 22 shows a display apparatus and a group of devices that are application targets of a control method of the display apparatus according to the fifth embodiment. The group of devices includes three each of a same imaging apparatus 1910, a same color converting apparatus 1920, and a same image display apparatus 1930. There are three combinations of devices: device sets (A) 1901 to (C) 1903. An example of a case where an application of the fifth embodiment is assumed is a movie set. On a movie set, a same subject is sometimes simultaneously photographed from a plurality of different angles. In this case, the imaging apparatus 1910 may be installed in plurality, the image display apparatus 1930 may be connected to each imaging apparatus 1910, and a photographed image taken by each imaging apparatus 1910 may be checked by each image display apparatus 1930. In addition, the color converting apparatus 1920 may be connected between the imaging apparatus 1910 and the image display apparatus 1930 to enable the user to check an image in a desired look (color appearance).

The color converting apparatus 1920 adjusts a color of input image data with a 1D LUT or a 3D LUT and outputs the image data. In an application example such as a movie set, it is important that the device sets (A) 1901 to (C) 1903 are all adjusted to a same look. In other words, an LUT set to the color converting apparatus 1920 of each device set must be the same. However, there may be cases where, for example, an LUT setting of the color converting apparatus 1920 is changed in only one of the device sets due to an erroneous operation or the like. When photography proceeds with the user unaware of the changed LUT setting, a tinge of only one of multiple angles is changed and is therefore unfavorable. In the fifth embodiment, in a case where there are a plurality of device sets having a same cooperation setting, the cooperation setting of each device set is monitored and, when a change of the cooperation setting occurs, the user can be notified of the change.

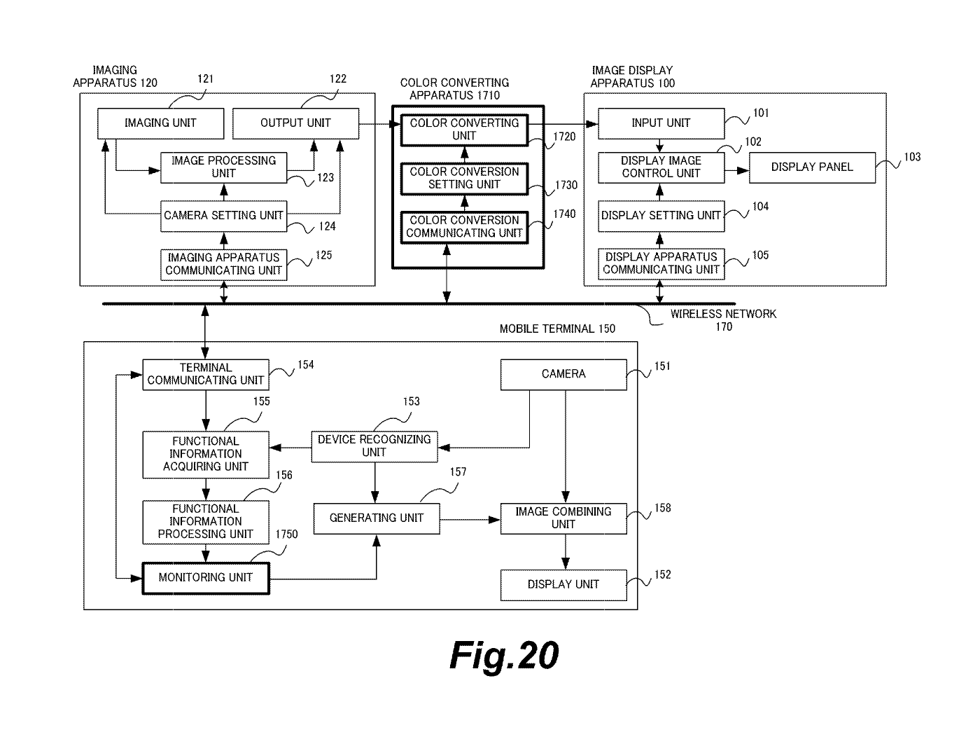

FIG. 20 is a block diagram showing a functional configuration of the group of devices described above. A difference between a configuration of the group of devices shown in FIG. 20 and the configuration of the group of devices described in the first embodiment is a color converting apparatus 1710 and an addition of a monitoring unit 1750 to the mobile terminal 150. The color converting apparatus 1710 includes a color converting unit 1720, a color conversion setting unit 1730, and a color conversion communicating unit 1740.

The color converting unit 1720 performs color conversion using a 1D LUT or a 3D LUT on image data input from the output unit 122 of the imaging apparatus 120 and outputs the color-converted image data. 1D LUT is a table of one-dimensional numerical values for gamma adjustment and 3D LUT is table of three-dimensional numerical values for adjusting color gamut or a partial color of an image. The color converting unit 1720 performs color conversion using an LUT set by the color conversion setting unit 1730. An arbitrary LUT file specified by the user can be read and applied as a 1D LUT or a 3D LUT.

The color conversion setting unit 1730 sets an LUT to be used by the color converting unit 1720 for color conversion. The color conversion setting unit 1730 possesses a plurality of LUT files and by changing an LUT file to be read in accordance with a specification by the user, the user can check an image in various looks. In addition to LUT files held by the color conversion setting unit 1730 in advance, the user may be enabled to read an arbitrary LUT file into the color converting apparatus 1710 from the outside.

The color conversion communicating unit 1740 communicates data with the terminal communicating unit 154 of the mobile terminal 150 via the wireless network 170. The terminal communicating unit 154 acquires, via the color conversion communicating unit 1740, information on an LUT applied to the color converting unit 1720 from the color conversion setting unit 1730 as functional information of the color converting apparatus 1710.

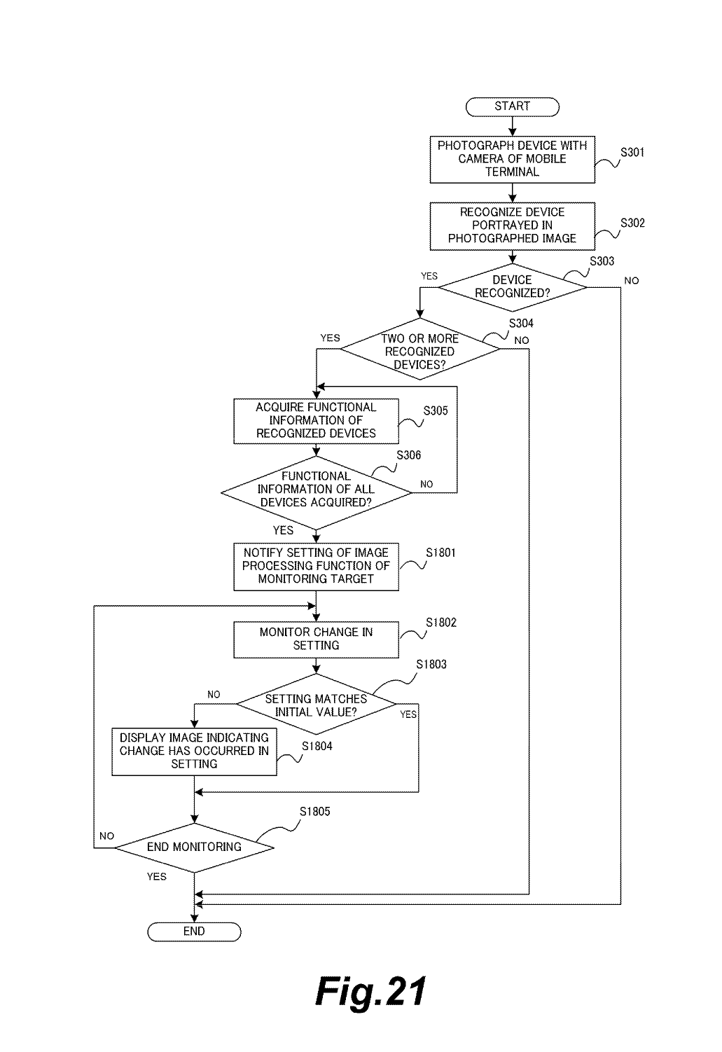

Next, processing for displaying a functional information image according to the fifth embodiment will be described with reference to the flow chart shown in FIG. 21. A difference from the flow chart shown in FIG. 3 according to the first embodiment is that processing of S1801 to S1805 is performed after recognizing all devices (after executing S306). Processing from S301 to S306 is similar to that of the first embodiment. Detailed descriptions of processing already described in the first embodiment will be omitted.

### S301 to S306

In steps S301 to S306, processing is performed for recognizing the imaging apparatus 1910, the color converting apparatus 1920, and the image display apparatus 1930 respectively included in the device sets (A) 1901 to (C) 1903 with the camera 151 of the mobile terminal 150. Moreover, in this case, it is assumed that Log gamma and DCI color gamut are set as common image processing functions in the imaging apparatus 1910, the color converting apparatus 1920, and the image display apparatus 1930 included in each device set. Furthermore, it is assumed that the color converting apparatuses are capable of performing color conversion on image data of Log gamma and DCI color gamut and that 3D LUT (file name: 0001) is commonly set to the respective device sets.

### S1801

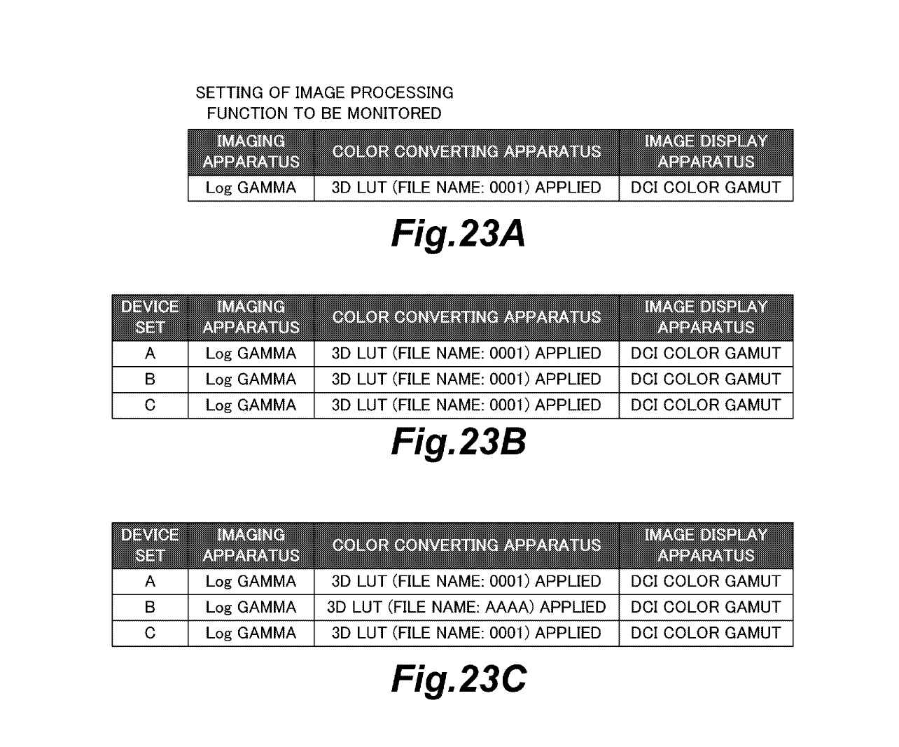

In step S1801, the functional information processing unit 156 notifies the monitoring unit 1750 of a setting of an image processing function that is a target on which detection of a change is to be performed (monitoring target) among settings of the image processing function (referred to as cooperation settings) in each recognized device set. The functional information processing unit 156 further notifies the monitoring unit 1750 of contents (a value) of the cooperation setting that is set to each device set as an initial value. A cooperation setting and an initial value thereof of a monitoring target are shown in FIG. 23A. In this case, cooperation settings to be monitored are Log gamma of the imaging apparatus 1910, 3D LUT (file name: 0001) of the color converting apparatus 1920, and DCI color gamut of the image display apparatus 1930. The mobile terminal 150 according to the fifth embodiment notifies the user when it is detected that the cooperation settings that are monitoring targets have changed from these initial values. In this case, settings of an image processing function of each device which are expected to change due to an erroneous operation or the like are considered monitoring targets. Moreover, the cooperation settings and monitoring targets described above are merely examples and are not limited thereto. Which function of which device is to be considered a monitoring target may be determined in advance or may be arbitrary determined by the user.

### S1802

In step S1802, the monitoring unit 1750 starts monitoring a cooperation setting. The monitoring unit 1750 periodically and repetitively acquires settings from the camera setting unit 124, the color conversion setting unit 1730, and the display setting unit 104 via the terminal communicating unit 154. The monitoring unit 1750 compares repetitively acquired contents of cooperation settings with the initial values acquired in step S1801.

### S1803

In step S1803, when a newly-acquired current cooperation setting matches the initial value (YES), the monitoring unit 1750 advances to step S1805. FIG. 23B illustrates a case where a current cooperation setting matches an initial value. On the other hand, when a newly-acquired current cooperation setting does not match the initial value (NO), the monitoring unit 1750 advances to step S1804. FIG. 23C illustrates a case where a current cooperation setting does not match an initial value. In the example shown in FIG. 23C, only the setting of the color converting apparatus 1920 of the device set B has changed to a state in which a 3D LUT with a file name: AAAA is being read and does not match the initial value shown in FIG. 23B. In this case, the monitoring unit 1750 notifies the generating unit 157 that the setting of the color converting apparatus 1920 of the device set B has changed from its initial value.

### S1804

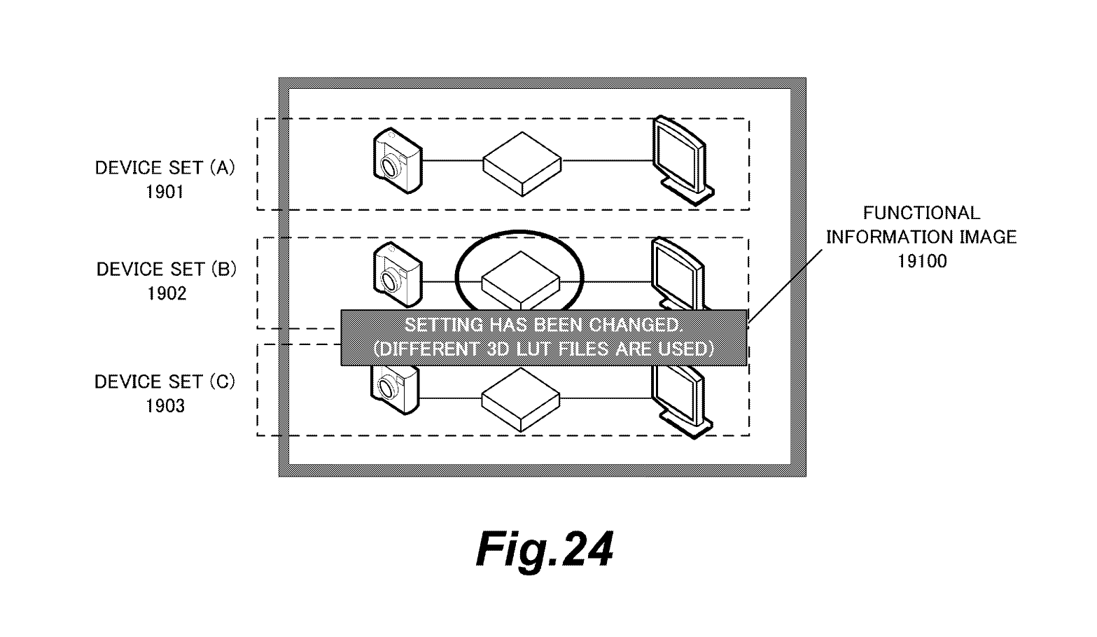

In step S1804, the generating unit 157 generates a functional information image indicating that a change to a cooperation setting has occurred. This is a functional information image for notifying the user that a change in a setting of an image processing function has occurred in at least any of the devices included in a combination having a common image processing function. In this case, the generating unit 157 generates a functional information image 19100 shown in FIG. 24 which indicates that the setting of the color converting apparatus 1920 of the device set B has changed from its initial value and outputs the functional information image 19100 to the image combining unit 158. Accordingly, a functional information image indicating in which device a cooperation setting has changed from its initial value (in this case, a circle enclosing the color converting apparatus 1920 of the device set B) and an image indicating specific contents of the change (in this case, a character string notifying that a 3D LUT has been rewritten) are displayed.

### S1805

In step S1805, the monitoring unit 1750 checks whether an instruction to end monitoring has been issued by the user. The monitoring unit 1750 repetitively performs processing of steps S1802 to S1804 and continues monitoring changes to cooperation settings of the devices until an instruction to end monitoring is issued.

As described above, in the fifth embodiment, cooperation settings of a plurality of devices are monitored, and by presenting a change in the settings to a user when the user alters the settings by mistake, the user can more readily notice unintentional changes in the cooperation settings due to an erroneous operation or the like.

Moreover, while an example in which identification information of each device is encoded in an AR code has been described in the embodiments presented above, information on an image processing function (functional information) of each device may be encoded in an AR code. In this case, instead of acquiring functional information from each device via the wireless network 170, the functional information acquiring unit 155 acquires functional information of each device by analyzing an AR code portrayed in a photographed image. In a case where an AR code is a fixed marker that is printed on a housing, information on a plurality of image processing functions that can be executed by the device is encoded in the AR code. In this case, when information on current operation settings must be acquired, information on current operation settings is acquired from each device via the wireless network 170. In a case where an AR code is a variable marker displayed on a screen, information on current operation settings may also be encoded in the AR code.

The respective embodiments described above can be implemented in a mode in which a function or processing of each functional block is realized by having a computer, a processor, or a CPU execute a program stored, recorded, or saved in a storage device or a memory. It is to be understood that the scope of the present invention also includes configurations including a processor and a memory, the memory storing a program realizing functions of the respective functional blocks described in the embodiments present above when executed by a computer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-139933, filed on Jul. 13, 2015, which is hereby incorporated by reference herein in its entirety.

What is claimed is:

1. A display apparatus comprising:
an imaging unit;
a first acquiring unit configured to acquire a photographed image obtained by photographing a plurality of devices by the imaging unit;
a recognizing unit configured to recognize each device portrayed in the photographed image;
a second acquiring unit configured to acquire information on an image processing function of each of the devices; and
a display unit configured to display the photographed image and also, in a case where there is a combination of devices having a common image processing function from among the recognized devices, displaying an image indicating at least one of information on the combination and information on the common image processing function.

2. The display apparatus according to claim 1, wherein
the second acquiring unit acquires, with respect to a device capable of switchably executing a plurality of image processing functions by changing settings, information on the plurality of image processing functions, and
in a case where there is a combination of devices having at least one image processing function from among the plurality of switchable image processing functions among the recognized devices, the display unit displays an image indicating at least one of information on the combination and information on the common image processing function.

3. The display apparatus according to claim 1, further comprising a setting unit configured to set a device, which is included in the combination, so as to operate in the common image processing function.

4. The display apparatus according to claim 3, further comprising input unit configured to accept an input of an instruction from a user, wherein
in a case where an instruction from the user to set each device included in the combination so as to operate in the common image processing function is input, the setting unit sets a device included in the combination so as to operate in the common image processing function.

5. The display apparatus according to claim 1, wherein in a case where there are a plurality of combinations, the display unit displays for each combination an image indicating information on the common image processing function.

6. The display apparatus according to claim 1, wherein the recognizing unit recognizes each of the devices by analyzing an image of a marker included in each of the devices.

7. The display apparatus according to claim 1, wherein the second acquiring unit acquires information on an image processing function of each of the devices by analyzing an image of a marker included in each of the devices.

8. The display apparatus according to claim 1, further comprising a communicating unit configured to communicate with each of the devices, wherein
the second acquiring unit uses the communicating unit to acquire, from each of the devices, information on an image processing function of each of the devices.

9. The display apparatus according to claim 1, further comprising an input unit configured to accept an input of an instruction for specifying an image processing function from a user, wherein
in a case where there is a combination of devices from among the recognized devices of which the common image processing function is the image processing function specified by the user, the display unit displays an image indicating the devices that are included in the combination from among the recognized devices.

10. The display apparatus according to claim 9, wherein in a case where there is no combination of devices from among the recognized devices of which the common image processing function is the image processing function specified by the user, the display unit displays an image indicating that there is no combination of devices having the image processing function specified by the user as the common image processing function from among the recognized devices.

11. The display apparatus according to claim 9, further comprising a third acquiring unit configured to acquire information from a storage apparatus that stores information on an image processing function of a prescribed device, wherein
in a case where there is no combination of devices from among the recognized devices of which the common image processing function is the image processing function specified by the user, the third acquiring unit acquires from the storage apparatus information on a candidate device which enables, by being combined with the recognized devices, a combination of devices having an image processing function specified by the user as the common image processing function to be obtained, and
the display unit displays an image indicating information on the candidate device.

12. The display apparatus according to claim 1, wherein
the plurality of devices include a plurality of display apparatuses,
the second acquiring unit acquires information on an image processing function of each of the display apparatuses and information related to a state of calibration of each of the display apparatuses, and
in a case where there is a combination of display apparatuses among the recognized display apparatuses having a common image processing function and calibrated so that display characteristics thereof are substantially the same, the display unit displays an image indicating the display apparatuses that are included in the combination from among the recognized display apparatuses.

13. The display apparatus according to claim 12, wherein in a case where there is a combination of display apparatuses which have a common image processing function and for which display characteristics can be made substantially the same by calibrating at least one display apparatus from among the recognized display apparatuses, the display unit displays an image indicating the display apparatuses that are included in the combination from among the recognized display apparatuses.

14. The display apparatus according to claim 1, wherein the second acquiring unit repetitively acquires information on an image processing function set to each of the devices, and
in a case where there is a change in a setting of the image processing function in at least any of the devices included in the combination based on the information that is repetitively acquired by the second acquiring unit, the display unit displays an image that notifies the change.

15. The display apparatus according to claim 1, wherein information on the image processing function includes information on settings of at least any of a size, a color format, gamma, a color gamut, and permission/inhibition of development of image data in image processing of at least any of displaying, recording, transmitting, and developing.

16. A control method for a display apparatus including an imaging unit, the control method comprising:
capturing an image with the imaging unit;
acquiring a photographed image obtained by photographing a plurality of devices by the imaging unit;
recognizing each device portrayed in the photographed image;
acquiring information on an image processing function of each of the devices; and
displaying the photographed image and also, in a case where there is a combination of devices having a common image processing function from among the recognized devices, displaying an image indicating at least one of information on the combination and information on the common image processing function.

17. A non-transitory computer readable storage medium having stored thereon a computer program comprising instructions, which, in a case where executed by a computer, cause the computer to execute respective steps of a control method for a display apparatus including an imaging unit, the program causing a computer to execute:
capturing an image with the imaging unit;
acquiring a photographed image obtained by photographing a plurality of devices by the imaging unit;
recognizing each device portrayed in the photographed image;
acquiring information on an image processing function of each of the devices; and
displaying the photographed image and also, in a case where there is a combination of devices having a common image processing function from among the recognized devices, displaying an image indicating at least one of information on the combination and information on the common image processing function.
